(19) United States
(12) Patent Application Publication
(10) Pub. No.: US 2017/0180889 A1
(43) Pub. Date: Jun. 22, 2017

(54) IMPLANTABLE HEARING PROSTHESIS WITH DUAL ACTUATION

(71) Applicants: Joris WALRAEVENS, Mechelen (BE); Marcel VOSSENBERG, Mechelen (BE); Rishubh VERMA, Mechelen (BE)

(72) Inventors: Joris WALRAEVENS, Mechelen (BE); Marcel VOSSENBERG, Mechelen (BE); Rishubh VERMA, Mechelen (BE)

(21) Appl. No.: 15/159,335

(22) Filed: May 19, 2016

Related U.S. Application Data
(60) Provisional application No. 62/268,777, filed on Dec. 17, 2015.

(51) Int. Cl. H04R 25/00; H04R 23/02

(52) U.S. Cl. CPC H04R 25/606; H04R 23/02

(57) ABSTRACT

A device including a hearing prosthesis configured to provide mechanical stimulation to two separate portions of a barrier between the middle ear and the inner ear in an alternating manner to evoke a hearing percept. In some embodiments, the device is configured to apply mechanical stimulation to a round window of the cochlea and an oval window of the cochlea in an alternating manner, thereby evoking the hearing percept.

### CROSS-REFERENCE TO RELATED APPLICATIONS

This application claims priority to Provisional U.S. Patent Application No. 62/268,777, entitled IMPLANTABLE HEARING PROSTHESIS WITH DUAL ACTUATION, filed on Dec. 17, 2015, naming Joris WALRAEVENS of Mechelen, Belgium as an inventor, the entire contents of that application being incorporated herein by reference in its entirety.

### BACKGROUND

Hearing loss is generally of two types, conductive and sensorineural. Sensorineural hearing loss is due to the absence or partial destruction of the cochlear hair cells which transduce sound into nerve impulses. Conductive hearing loss occurs when the natural mechanical pathways that provide sound in the form of mechanical energy to cochlea are impeded, for example, by damage to the ossicular chain or ear canal. Various hearing prostheses have been developed to provide individuals suffering from moderate to profound sensorineural hearing loss with the ability to perceive sound. For example, cochlear implants have an electrode assembly which is implanted in the cochlea. In operation, electrical stimuli are delivered to the auditory nerve via the electrode assembly, thereby bypassing the inoperative hair cells to cause a hearing percept.

For a variety of reasons, individuals with mild sensorineural hearing loss are typically not candidates for a cochlear implant. Rather, such individuals receive an acoustic hearing aid. Hearing aids rely on principles of air conduction to transmit acoustic signals to the cochlea. In particular, hearing aids amplify received sound and transmit the amplified sound into the ear canal. This amplified sound reaches the cochlea in the form of mechanical energy, causing motion of the perilymph and stimulation of the auditory nerve.

Unfortunately, not all individuals suffering from mild sensorineural hearing loss are able to derive suitable benefit from hearing aids. For example, some individuals are prone to chronic inflammation or infection of the ear canal. Other individuals have malformed or absent outer ear and/or ear canals resulting from a birth defect, or as a result of medical conditions such as Treacher Collins syndrome or Microtia.

For these and other individuals, another type of hearing prosthesis has been developed in recent years. This hearing prosthesis, commonly referred to as a middle ear implant, converts received sound into a mechanical force that is applied to the ossicular chain or directly to the cochlea, via an actuator implanted in or adjacent to the middle ear cavity.

### SUMMARY

According to an exemplary embodiment, there is a device comprising a hearing prosthesis configured to provide mechanical stimulation to two separate portions of a barrier between the middle ear and the inner ear in an alternating manner to evoke a hearing percept.

According to another exemplary embodiment, there is a hearing prosthesis, comprising at least one actuator and a force transfer apparatus configured to transfer force from the at least one actuator to two separate locations of a beginning of a cochlea in a reciprocating manner.

According to another exemplary embodiment, there is a hearing prosthesis, comprising at least one actuator, wherein the hearing prosthesis is configured to apply a first force to a round window of a cochlea and apply a separate second force to an oval window of the cochlea, such that deformation of the round window due to the respective applied force is balanced by at least about a substantially opposite deformation of the oval window, and deformation of the oval window due to the respective applied force is balanced by at least about a substantially opposite deformation of the round window.

According to another exemplary embodiment, there is a method, comprising capturing energy indicative of an ambient sound originating external to a recipient and artificially applying first stimulation to a round window of a cochlea of the recipient and artificially applying second stimulation to the oval window of the cochlea based on the captured energy to evoke a hearing percept, wherein the first and second stimulation is applied with an opposite phase.

### BRIEF DESCRIPTION OF THE DRAWINGS

Embodiments are described below with reference to the attached drawings, in which:

FIG. 1 is perspective view of a human ear;

FIG. 2 is a perspective view of an exemplary direct acoustic cochlear stimulator implanted in accordance with an exemplary embodiment;

FIG. 3 is a schematic depicting an exemplary implantable component in accordance with an exemplary embodiment;

FIG. 4A is a conceptual schematic of particulars of an interface regime between the hearing prosthesis and a cochlea of a recipient;

FIG. 4B is a conceptual schematic of particulars of a stimulation regime of the round window and the oval window of the cochlea by a hearing prosthesis;

FIGS. 4C and 4D are conceptual schematics of alternate particulars of a stimulation regime of the round window and the oval window of the cochlea by a hearing prosthesis;

FIGS. 5 and 6 are conceptual schematics of an exemplary results of the stimulation regime of FIG. 4A;

FIG. 7 is a schematic of an exemplary actuator assembly according to an exemplary embodiment;

FIGS. 8 and 9 are schematics depicting operation of the exemplary actuator of FIG. 7 according to an exemplary embodiment;

FIGS. 10-12 present charts presenting information pertaining to various modes of operation of the actuator of FIG. 7;

FIG. 13 is a schematic of another exemplary actuator assembly according to an exemplary embodiment;

FIG. 14 is a schematic of another exemplary actuator assembly according to an exemplary embodiment;

FIG. 15 is a schematic of another exemplary actuator assembly according to an exemplary embodiment;

FIG. 16 is a schematic of another exemplary actuator assembly according to an exemplary embodiment;

FIG. 17 is a schematic of another exemplary actuator assembly according to an exemplary embodiment;

FIG. 18 is a schematic of another exemplary actuator assembly according to an exemplary embodiment;

FIG. 19A is a schematic of an exemplary coupling arrangement of the actuator assembly including coupling components configured to couple to the windows of the cochlea;

FIG. 19B is a schematic of an alternate exemplary coupling arrangement of the actuator assembly including coupling components configured to couple to the windows of the cochlea, which also depicts an alternate actuation arrangement;

FIG. 19C is an exemplary embodiment of an alternate actuator assembly;

FIG. 19D is an exemplary embodiment of an alternate placement of an alternate actuator assembly; and

FIG. 20 depicts an exemplary flowchart representing an exemplary method according to an exemplary embodiment.

### DETAILED DESCRIPTION

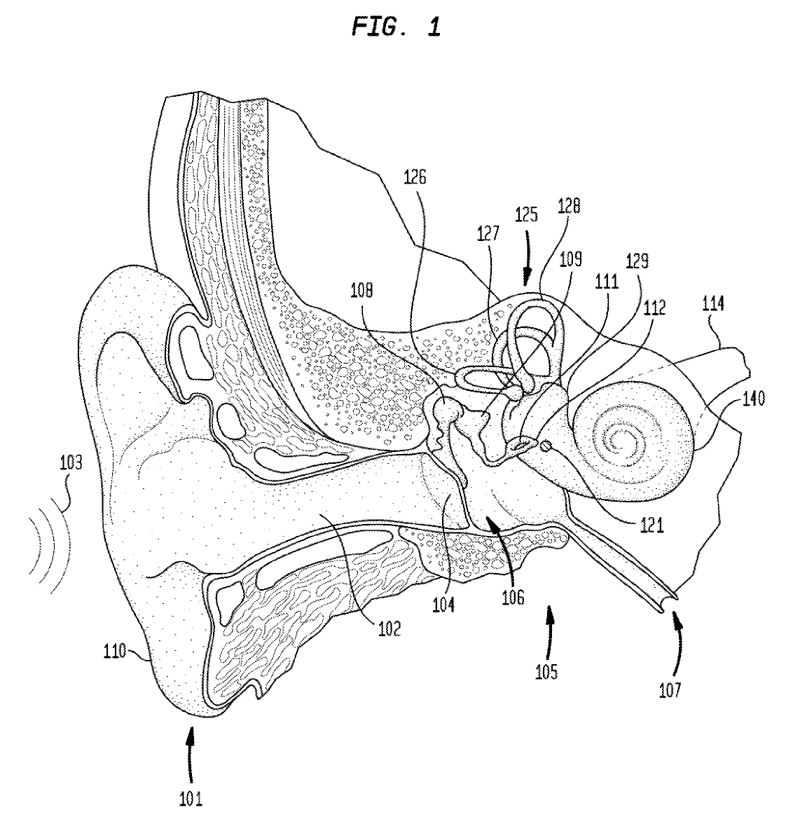

FIG. 1 is a perspective view of a human skull showing the anatomy of the human ear. As shown in FIG. 1, the human ear comprises an outer ear 101, a middle ear 105 and an inner ear 107. In a fully functional ear, outer ear 101 comprises an auricle 110 and an ear canal 102. An acoustic pressure or sound wave 103 is collected by auricle 110 and channeled into and through ear canal 102. Disposed across the distal end of ear canal 102 is a tympanic membrane 104 which vibrates in response to sound wave 103. This vibration is coupled to oval window or fenestra ovalis 112, which is adjacent round window 121. This vibration is coupled through three bones of middle ear 105, collectively referred to as the ossicles 106 and comprising the malleus 108, the incus 109, and the stapes 111. Bones 108, 109, and 111 of middle ear 105 serve to filter and amplify sound wave 103, causing oval window 112 to articulate, or vibrate in response to the vibration of tympanic membrane 104. This vibration sets up waves of fluid motion of the perilymph within cochlea 140. Such fluid motion, in turn, activates hair cells (not shown) inside cochlea 140. Activation of the hair cells causes nerve impulses to be generated and transferred through the spiral ganglion cells (not shown) and auditory nerve 114 to the brain (also not shown) where they cause a hearing percept.

As shown in FIG. 1, semicircular canals 125 are three half-circular, interconnected tubes located adjacent cochlea 140. Vestibule 129 provides fluid communication between semicircular canals 125 and cochlea 140. The three canals are the horizontal semicircular canal 126, the posterior semicircular canal 127, and the superior semicircular canal 128. The canals 126, 127, and 128 are aligned approximately orthogonally to one another. Specifically, horizontal canal 126 is aligned roughly horizontally in the head, while the superior 128 and posterior canals 127 are aligned roughly at a 45 degree angle to a vertical through the center of the individual's head.

Each canal is filled with a fluid called endolymph and contains a motion sensor with tiny hairs (not shown) whose ends are embedded in a gelatinous structure called the cupula (also not shown). As the orientation of the skull changes, the endolymph is forced into different sections of the canals. The hairs detect when the endolymph passes thereby, and a signal is then sent to the brain. Using these hair cells, horizontal canal 126 detects horizontal head movements, while the superior 128 and posterior 127 canals detect vertical head movements.

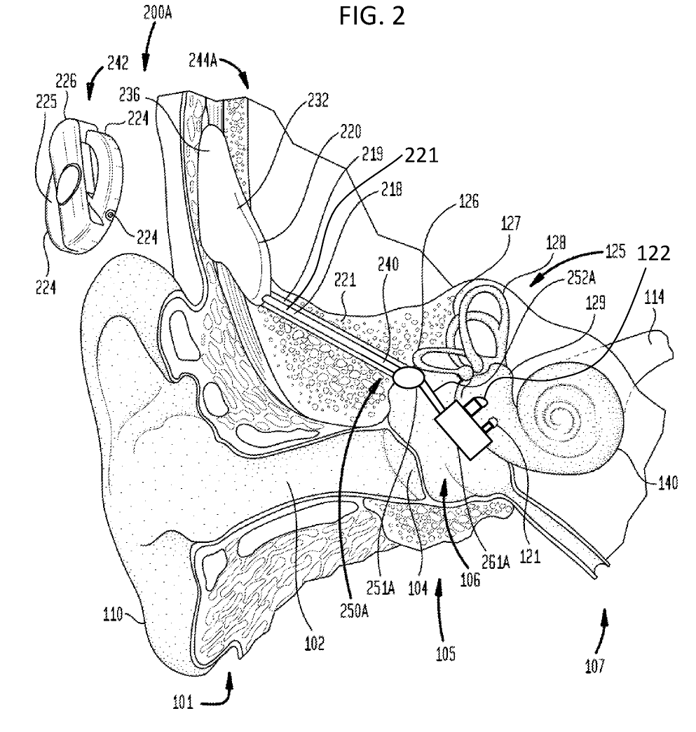

FIG. 2 is a perspective view of an exemplary direct acoustic cochlear stimulator 200A in accordance with some exemplary embodiments. Direct acoustic cochlear stimulator 200A comprises an external component 242 that is directly or indirectly attached to the body of the recipient, and an internal component 244A that is temporarily or permanently implanted in the recipient. External component 242 typically comprises two or more sound input elements, such as microphones 224 for detecting sound, a sound processing unit 226, a power source (not shown), and an external transmitter unit 225. External transmitter unit 225 comprises an external coil (not shown). Sound processing unit 226 processes the output of microphones 224 and generates encoded data signals which are provided to external transmitter unit 225. For ease of illustration, sound processing unit 226 is shown detached from the recipient.

Internal component 244A comprises an internal receiver unit 232, a stimulator unit 220, and a stimulation arrangement 250A in electrical communication with stimulator unit 220 via cable 218 extending thorough artificial passageway 219 in mastoid bone 221. Internal receiver unit 232 and stimulator unit 220 are hermetically sealed within a biocompatible housing, and are sometimes collectively referred to as a stimulator/receiver unit.

Internal receiver unit 232 comprises an internal coil (not shown), and optionally, a magnet (also not shown) fixed relative to the internal coil. The external coil transmits electrical signals (i.e., power and stimulation data) to the internal coil via a radio frequency (RF) link. The internal coil is typically a wire antenna coil comprised of multiple turns of electrically insulated platinum or gold wire. The electrical insulation of the internal coil is provided by a flexible silicone molding (not shown). In use, implantable receiver unit 232 is positioned in a recess of the temporal bone adjacent auricle 110.

In the illustrative embodiment of FIG. 2A, ossicles 106 have been explanted, thus revealing oval window 122.

Stimulation arrangement 250A comprises both the distal and proximal portions of cable 218 (221 and 240), an actuator 261A, an actuator mount member 251A, an actuator position arm 252A that extends from actuator mount member 251A and supports or at least holds actuator 261A in place relative to the outside of the cochlea 140. In an exemplary embodiment, actuator mount member 251A is osseointegrated to mastoid bone 221, or more particularly, to the exit of artificial passageway 219 formed in mastoid bone 221.

In this embodiment, stimulation arrangement 250A is implanted and/or configured such that a portion of the actuator 261A abuts the round window 121 and a portion of the actuator 261A abuts the oval window 122.

As noted above, a sound signal is received by microphone(s) 224, processed by sound processing unit 226, and transmitted as encoded data signals to internal receiver 232. Based on these received signals, stimulator unit 220 generates drive signals which cause actuation of actuator 261A. The mechanical motion of actuator 261A is transferred to the round window and the oval window in a dual but opposite phase manner such that a wave of fluid motion is generated in the cochlea. More particularly, because the round window and oval window provides fluid communication with the median canal of the cochlea 140, the motion of the actuator 261A is transferred to the activating the hair cells of the organ of Corti. Activation of the hair cells causes appropriate nerve impulses to be generated and transferred through the spiral ganglion cells (not shown) and auditory nerve 114 to cause a hearing percept in the brain.

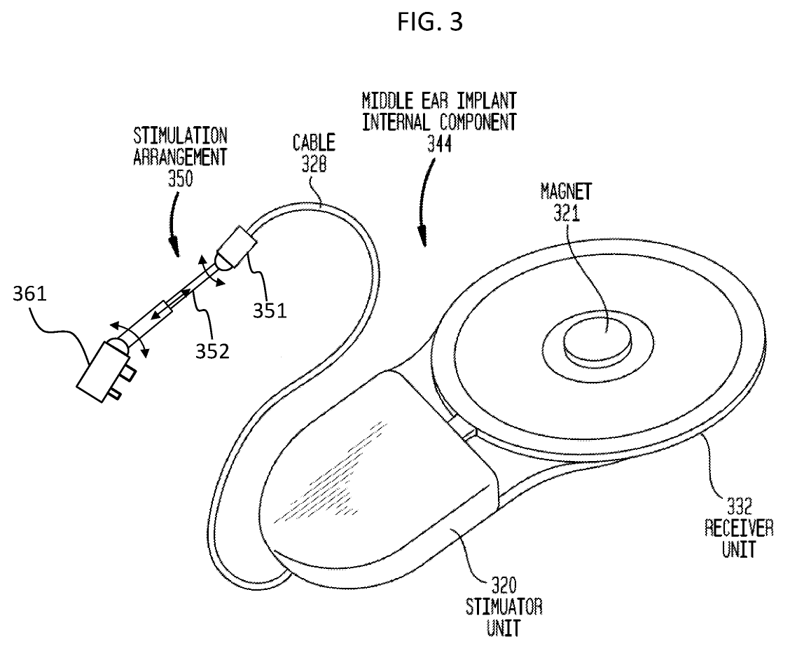

FIG. 3 is a perspective view of an exemplary internal component 344 of a middle ear implant which generally represents internal component 244A described above. Internal component 344 comprises an internal receiver unit 332, a stimulator unit 320, and a stimulation arrangement 350. As shown, receiver unit 332 comprises an internal coil (not shown), and a magnet 320 fixed relative to the internal coil. In some embodiments, internal receiver unit 332 and stimulator unit 320 are hermetically sealed within a biocompatible housing. This housing has been omitted from FIG. 3 for ease of illustration.

Stimulator unit 320 is connected to stimulation arrangement 350 via a cable 328, corresponding to cable 218 of FIG. 2. Stimulation arrangement 350 comprises an actuator assembly 361, corresponding to actuator 261A of FIG. 2, an actuator assembly mount member 351, corresponding to actuator assembly mount member 251A of FIG. 2, and an actuator assembly positioning arm 352, corresponding to the actuator assembly positioning arm 352 of FIG. 2. In an exemplary embodiment, actuator assembly mount member 351 is configured to be located in the artificial passageway 219 or adjacent thereto and fixed to the mastoid bone of the recipient. As indicated by the curved arrows of FIG. 3, the actuator assembly mount member 351 and the actuator assembly 361 are configured to enable articulation of the actuator assembly positioning arm 352 relative to those components. Further, as indicated by the straight arrow of FIG. 3, the actuation assembly positioning arm 352 is configured to telescope to provide longitudinal adjustment between the actuator assembly 361 and the actuator assembly mount member 251.

In operation, actuator 361 vibrates or otherwise moves the round window and the oval window of the cochlea in a dual but out of phase manner. The vibration of the round and oval window generates waves of fluid motion of the perilymph, thereby activating the hair cells of the organ of Corti. Activation of the hair cells causes appropriate nerve impulses to be generated and transferred through the spiral ganglion cells and auditory nerve 114.

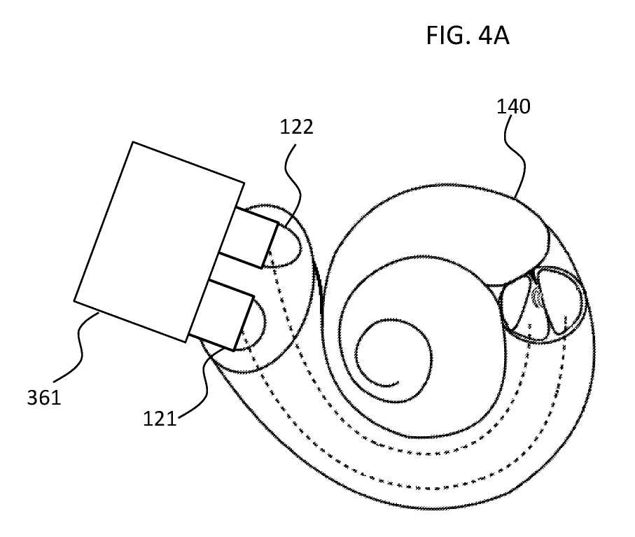

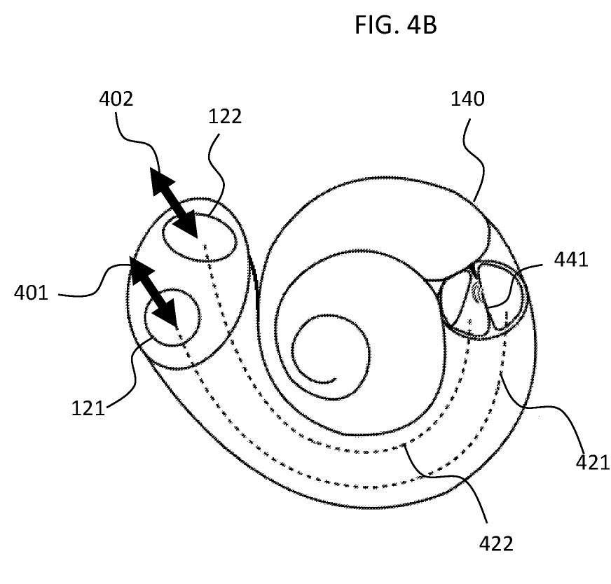

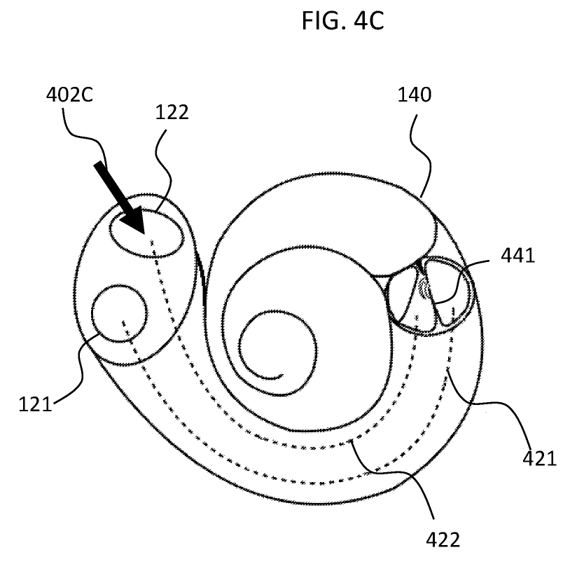

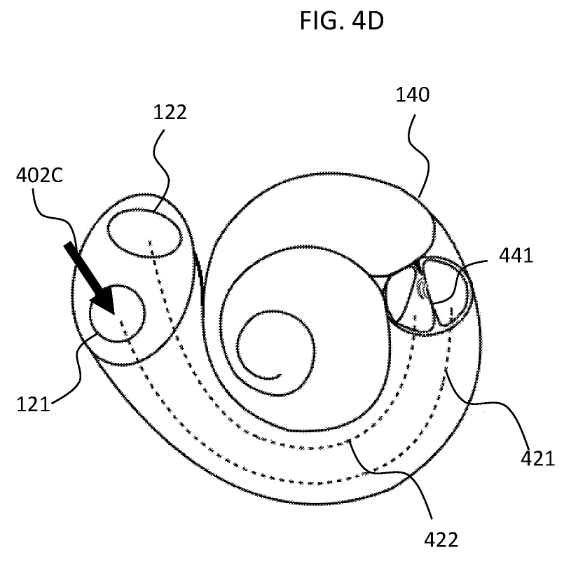

FIG. 4A depicts a high-level conceptual view of this concept, where actuator 361 is position outside cochlea 140. In this exemplary embodiment, the actuator 361 is configured to apply a compression force to the round window 121 and apply a tension force to the oval window 122, and visa-versa, in an alternating manner. FIG. 4B depicts a high-level conceptual view of the concept of FIG. 4A, where a compression force is applied to the round window 121 by the actuator assembly 361 and a tension force is applied to the oval window 122 by the actuator assembly 361, represented by arrows 401 and 402, respectively. This forces fluid away from the round window 121, as represented by fluid flow track 421, and pulls fluid towards the oval window 402, as represented by fluid flow path 422, which is bifurcated for most of the length of the cochlea by the cochlear partition 441. Subsequently, a compression force is applied to the oval window 122 by the actuator assembly 361 and a tension force is applied to the round window 121 by the actuator assembly 361, again represented by arrows 401 and 402, respectively. This forces fluid away from the oval window 122, as represented by fluid flow track 422, and pulls fluid towards the round window 121, as represented by fluid flow path 421.

That said, it is noted that some embodiments do not apply a tensile force on the windows. In this regard, FIGS. 4C and 4D conceptually represent the application of only compressive forces on the windows of the cochlea, in an alternating manner. In this regard, the actuator assembly 361 only applies compressive forces to the windows of the cochlea, leaving the window to which a force is not applied to deform in a natural manner.

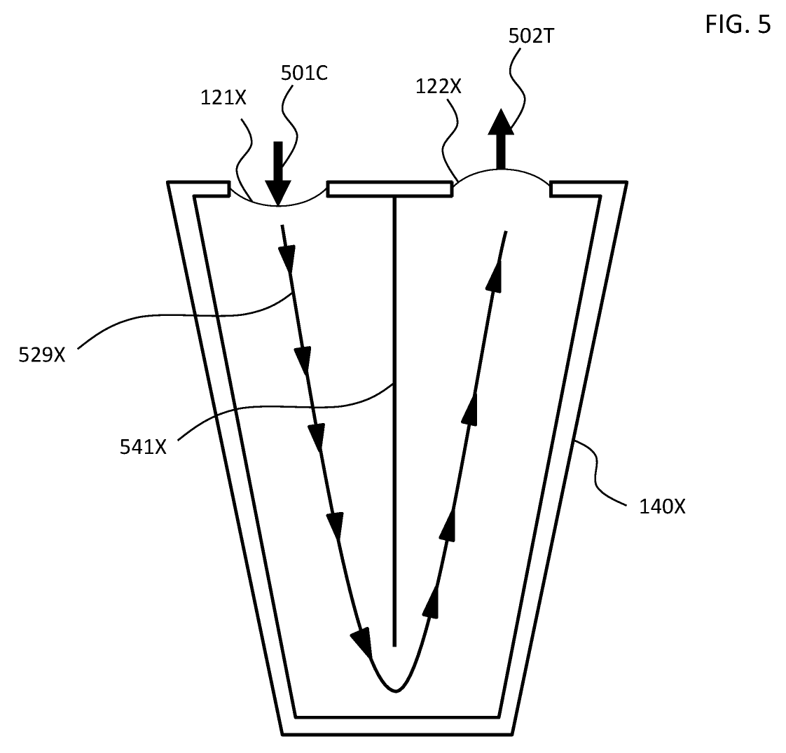

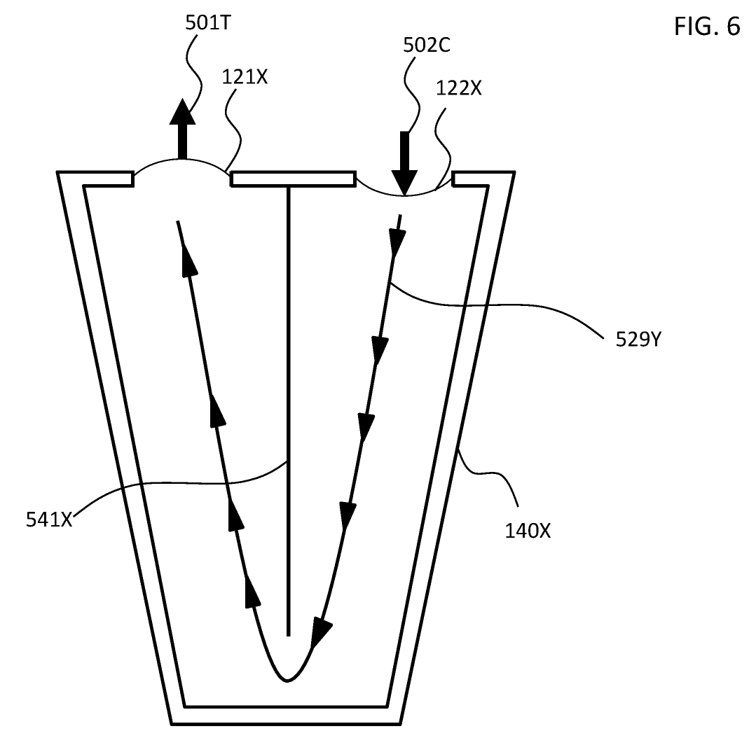

FIG. 5 presents a functional conceptual view of the principle of operation of the stimulating arrangement 350, with respect to a functional view of a cochlea, 140X. In FIG. 5, the actuator assembly 361 applies a tensile force 502T onto the oval window 122X, while simultaneously applying a compressive force 501C to the round window 121X. The applied tensile force 502T causes the oval window 122X to bow outward, and the compressive force 501C causes the round window 121X to bow inward, at the same time that the oval window 122X is bowing outward. This forces the fluid within the cochlea 140X to flow in the path as represented by fluid path 529X, where element 541X functionally represents the cochlear partition. After the actuation cycle portion represented by FIG. 5 is completed, the actuator assembly 360 reverses itself, as is functionally represented by FIG. 6, and then applies a compressive force 502C to the oval window 122X and a tensile force 501T to the round window 121X. The applied tensile force 501T causes the round window 121X to bow outward, and the compressive force 502C causes the oval window 122X to bow inward, at the same time that the round window 121X is bowing outward. This forces the fluid within the cochlea 140X to flow in the path as represented by fluid path 529Y, which is the opposite of fluid path 529X. Thus, in combination, FIGS. 5 and 6 represent an actuation cycle of the actuation assembly 361.

Some exemplary embodiments of the actuator assembly 361 will now be described.

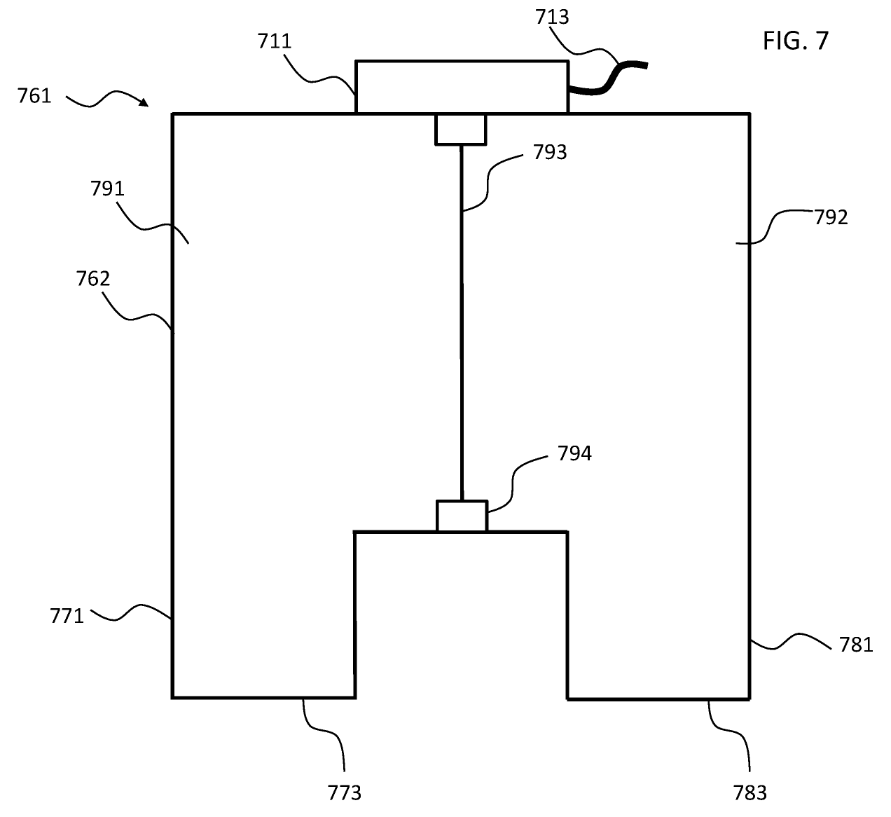

FIG. 7 depicts an exemplary actuator assembly 761, which, in some embodiments, corresponds to actuator assembly 361. In an exemplary embodiment, actuator assembly 761 includes a housing 762 that encompasses two chambers 791 and 792 and a piezoelectric disk 793 connected to the housing 762 by disk frame 794. In an exemplary embodiment, the piezoelectric disk 793 bifurcates the housing 763 to establish the aforementioned chambers. Actuator 761 includes sub-sections 771 and 781, which respectively apply force to separate windows of the cochlea. In an exemplary embodiment, the actuator 761 is configured or otherwise positioned such that subsection 771 applies a force to the round window, and subsection 781 applies a force to the oval window.

Chamber 791 is bounded by the housing walls, the piezoelectric disk assembly and membrane 773. Chamber 792 is bounded by the housing walls, the piezoelectric disk assembly and membrane 783. In an exemplary embodiment, the housing 762 is made of titanium, and the membranes 773 and 783 are also titanium (albeit much thinner titanium). In an exemplary embodiment, chambers 791 and 792 are filled with a fluid, such as in an exemplary embodiment, an incompressible fluid. In at least some exemplary embodiments the fluid filling the aforementioned chambers is a biocompatible fluid. In an exemplary embodiment, membranes 773 and 783 are titanium/titanium alloy membranes. Any arrangement of membranes (or diaphragms for that matter) that will enable the teachings detailed herein can be utilized in some embodiments.

Actuator assembly 761 further includes stimulator unit communication unit 711, which is in signal communication with the stimulator unit by cable 713 (which, in some exemplary embodiments, extends through the actuator assembly positioning arm and the actuator assembly mounting member to cable 318, which, as noted above, is in signal communication with the stimulator unit 320. Stimulator unit communication unit 711 receives signals from the stimulator unit 320 and passes those signals on to the piezoelectric disk assembly, or in some alternate embodiments, receives the signals from the stimulator unit 320, and converts those signals into electrical signals that are in turn provided to the piezoelectric disk assembly. In any event, the signals provided to the piezoelectric disk assembly, whatever their source, provide current thereto which in turn causes the piezoelectric disk assembly to deform, concomitant with piezoelectric principles of operation. Because the signals provided to the piezoelectric disk assembly are based upon captured sound captured by the DACS 200A, those signals drive the piezoelectric disk to vibrate or otherwise move in a manner governed by the captured sound.

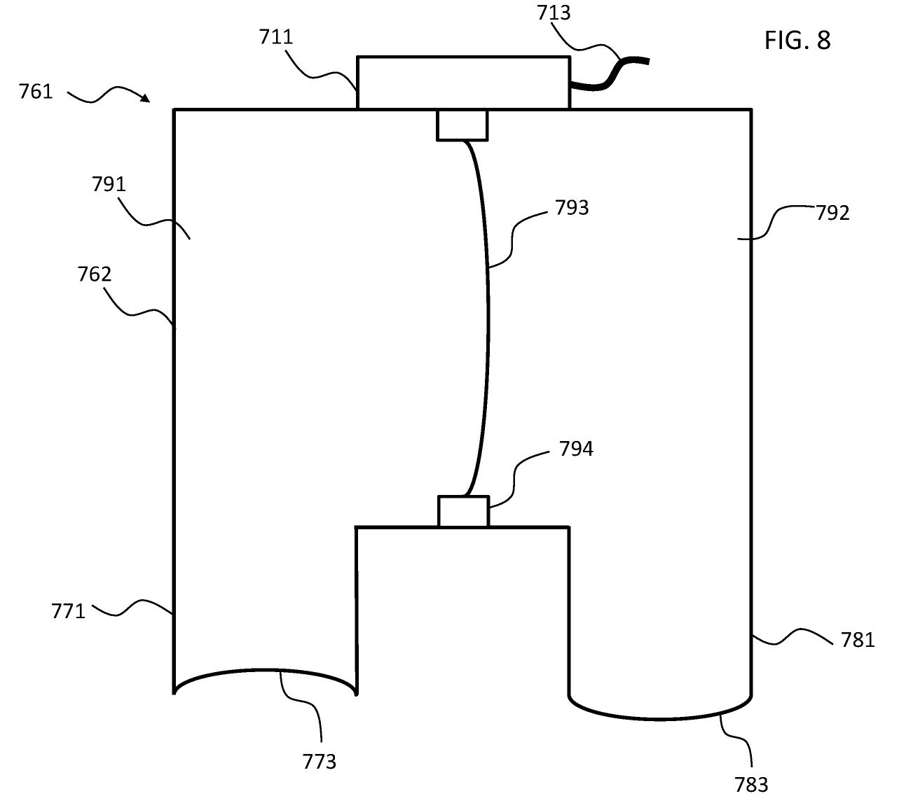

As noted above, the chambers 791 and 792 are filled with a fluid. In an exemplary embodiment, as the piezoelectric disk 793 deforms due to the application of the current signal from unit 711, the disk 793 bows into one chamber and away from the other chamber. In this regard, FIG. 8 depicts disk 793 in a deformed state such that the disk 793 bows into chamber 792 and away from chamber 791. The deformation of the disk 793 has the effect of reducing the volume in chamber 792 and increasing the volume of chamber 791, if all other things were equal. However, as noted above, chamber 792 is bounded in part by the diaphragm/membrane 783, in chamber 791 is bounded in part by the diaphragm/membrane 773. In this exemplary embodiment, these membranes are configured to flex, and thus at least partially compensate for the respective changes in the volumes of the chambers. As can be seen in FIG. 8, membrane 783 has bowed outwards, and membrane 773 has bowed inwards. Membrane 783 bows outwards because the disk 793 has bowed into chamber 792, thus forcing the fluid therein to be displaced, which displacement bows membrane 783 outward. Conversely, membrane 773 bows inwards because disk 793 has bowed away from chamber 791, thus forcing the fluid therein to be displaced, which displacement bows membrane 773 inward. Accordingly, as can be seen, in this exemplary embodiment, the actuator assembly 361 provides dual actuation, where the actuation components are out of phase with one another.

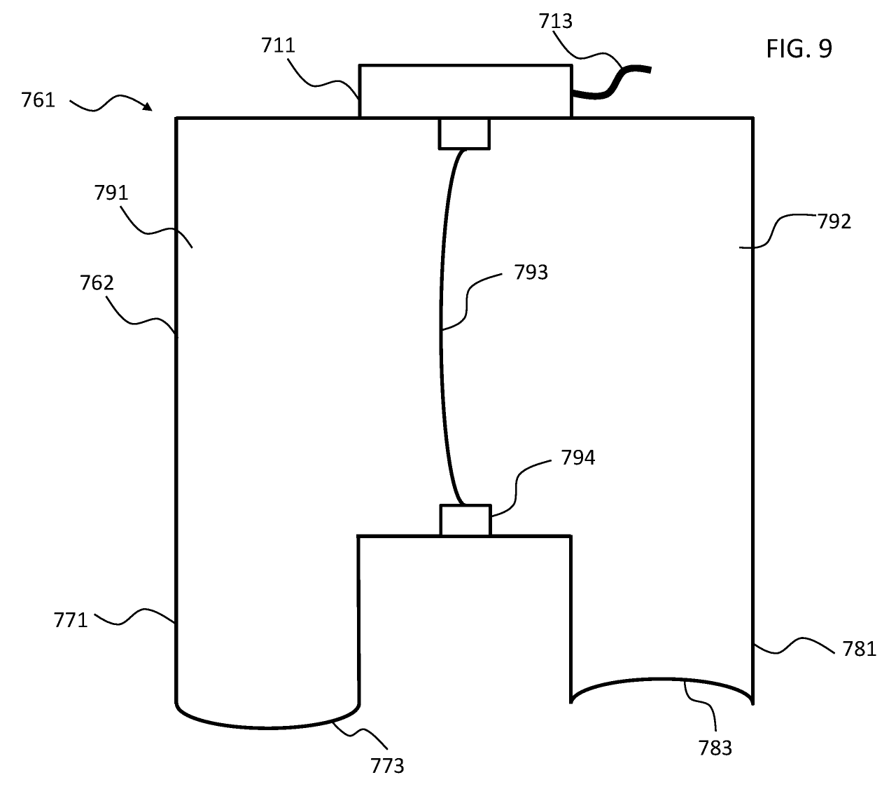

FIG. 9 depicts the actuator assembly 761 in the state where the current applied to the piezoelectric disk 793 via unit 711 is either reversed and/or canceled (with regard to the latter, the piezoelectric disk 793 can have a non-deformed state such that the piezoelectric disk 793 bows inward into chamber 791, in the absence of current—in an alternate embodiment, the opposite is the case). As can be seen, FIG. 9 depicts disk 793 in a deformed state such that the disk 793 bows into chamber 791 and away from chamber 792. The deformation of the disk 793 has the effect of reducing the volume in chamber 791 and increasing the volume of chamber 792, if all other things were equal. However, as noted above, chamber 792 is bounded in part by the diaphragm/membrane 783, in chamber 791 is bounded in part by the diaphragm/membrane 773. As can be seen in FIG. 8, membrane 773 has bowed outwards, and membrane 783 has bowed inwards. Membrane 773 bows outwards because the disk 793 has bowed into chamber 791, thus forcing the fluid therein to be displaced, which displacement bows membrane 773 outward. Conversely, membrane 783 bows inward because disk 793 has bowed away from chamber 792, thus forcing the fluid therein to be displaced, which displacement bows membrane 783 inward. Accordingly, as can be seen, in this exemplary embodiment, the actuator assembly 361 provides dual actuation, where the actuation components are out of phase with one another, reversing the actuating components of the portion of the cycle presented in FIG. 8.

In an exemplary embodiment, the cycle of FIGS. 8 and 9 is repeated in accordance with the sound captured by the system 200A. In an exemplary embodiment, the frequency at which the cycles occur corresponds to the frequency of the given sound that is captured by the system 200A.

In an exemplary embodiment, membranes 773 and 783 are coupled to the round window 121 and the oval window 122, respectively, of the cochlea 140. In an exemplary embodiment, this coupling is achieved via a biocompatible adhesive. In other embodiments, the coupling is achieved via micro sutures between the tissue of the aforementioned windows and a modified surface of the aforementioned membranes. Moreover, in an exemplary embodiment, while in some embodiments, the aforementioned membranes are in direct contact with the aforementioned windows, in some alternate embodiments, the aforementioned membranes in indirect contact with the aforementioned windows (e.g., connection rods or pads can be placed between the various components). Still further, in an exemplary embodiment, the membranes are not necessarily coupled to the respective windows. In this regard, in an exemplary embodiment, the deformation of the membranes only results in a compressive force applied to the respective windows. That is, there is no tensile force applied to the respective windows. Instead, the window to which a force is not applied deforms owing to the compressive force applied to the opposite window. That said, in an alternate embodiment, the actuator assembly 761 is configured to apply only tensile forces of the respective windows corollary to all this is that in at least some exemplary embodiments, the actuator assembly 761 is configured so as to substantially relax with respect to the periods where the actuator is not applying a force on a given window so as to allow the given window to deform naturally or substantially or effectively naturally deform.

In view of the above, in at least some exemplary embodiments, there is a device, such as DACS 200A, comprising a hearing prosthesis configured to provide mechanical stimulation (such as the stimulation applied by actuator assembly 361) to two separate portions of a barrier between the middle ear and the inner ear (such as the round window and the oval window of the proximal portion of the cochlea) in an alternating manner to evoke a hearing percept. In some exemplary embodiments, the hearing prosthesis is configured to apply a push-pull stimulation to the round window and a pull-push stimulation to the oval window, where the push stimulation to the round window is accompanied by a pull stimulation to the oval window, and visa-versa. That said, in an alternate embodiment, the hearing prosthesis is configured to apply a push stimulation to the round window and push stimulation to the oval window, where the push stimulation to the round window is not accompanied by a pull stimulation to the oval window, and visa-versa.

That said, in an alternate embodiment, the hearing prosthesis is configured to apply a pull stimulation to the round window and pull stimulation to the oval window, where the pull stimulation to the round window is not accompanied by a push stimulation to the oval window, and visa-versa. It is further noted that in an alternate embodiment, the actuator assembly of the hearing prosthesis is configured so as to selectively enable a push and selectively enable a pull (e.g., the actuator can operate in a push-pull mode, a push-no pull (relaxed) mode, a pull-no push (relaxed) mode).

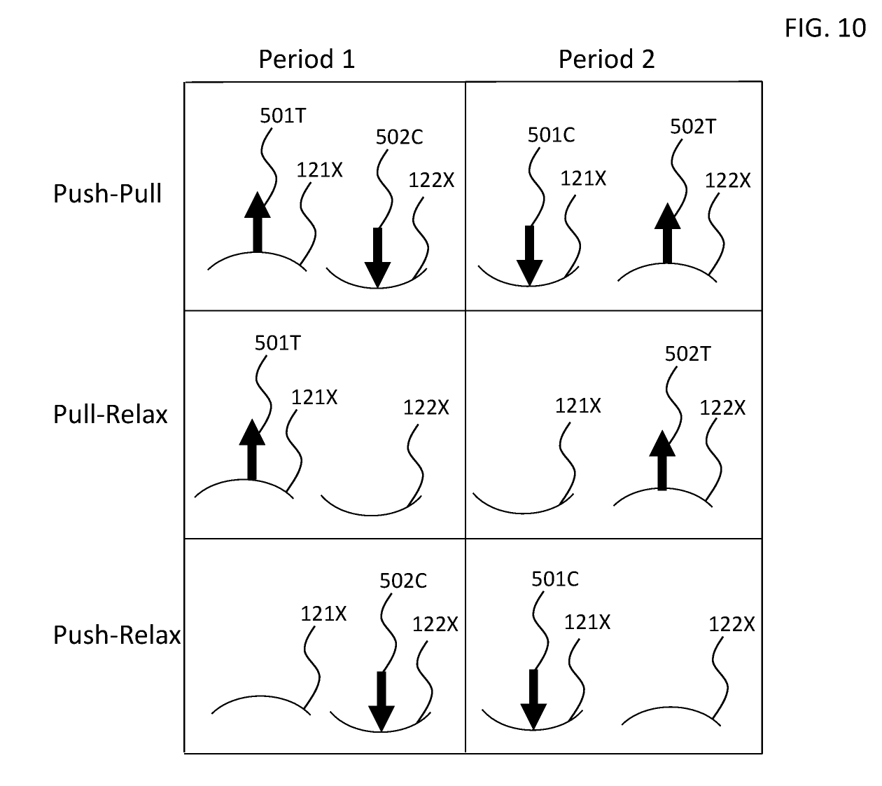

As noted above, the mechanical stimulation is applied to the two separate portions of the barrier (e.g., the round window and the oval window) between the middle ear and the inner ear. In an exemplary embodiment, the mechanical stimulation applied thereto is a stimulation that deforms, during a first temporal period, a first portion of the two portions while at least permitting a second portion of the two portions to deform in a substantially opposite manner (e.g., the actuator is operating in the push-pull mode, or the push-relaxed mode, or the pull-relaxed mode). In the exemplary embodiment, the mechanical stimulation is also applied during a second temporal period separate from the first temporal period. The stimulation of the second temporal period deforms the second portion while at least permitting the first portion to deform in a substantially opposite manner. In this exemplary embodiment, the stimulations applied during the first temporal period and the second temporal period correspond to stimulation of the two separate portions in the alternating manner. FIG. 10 depicts a conceptual schematic depicting deformation and of the conceptual round window 121X and the oval window 122X and force application thereto in the push-pull mode for two different temporal periods (Period 1 and Period 2), the deformation and force application in the pull-relax mode for two different temporal periods, and the deformation and force application in the push-relax mode for two different temporal periods.

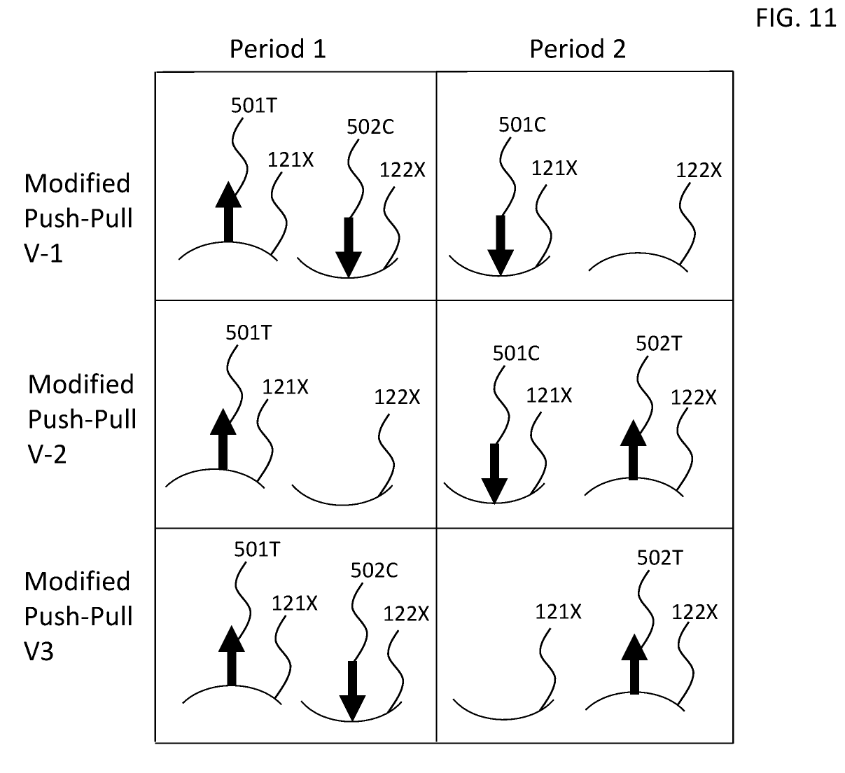

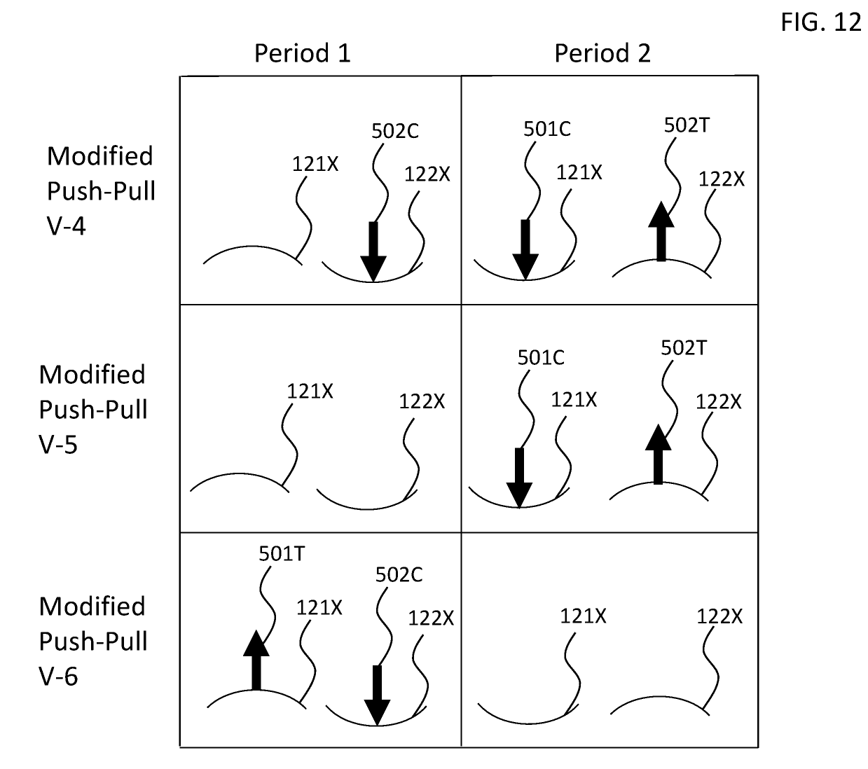

FIGS. 11 and 12 provide some additional conceptual schematics of modified push-pull (versions (“V”) 1-6) for two different temporal periods. It is noted that while the embodiments depicted in FIGS. 10-12 present force application to the barrier between the middle ear and the inner ear such that the oval window deforms inward and the round window deforms outward in the first temporal period, in some alternate embodiments, the force application is such that the oval window deforms outward and the round window deforms inward in the first temporal period.

To be clear, while various embodiments have utilitarian value, at least some embodiments operate in the push-pull mode such that, with respect to the mechanical stimulation applied to the barrier, the stimulation is a stimulation that deforms, during a first temporal period, a first portion of the two portions while deforming the second portion of the two portions in a substantially opposite manner and, during a second temporal period separate from the first temporal period, deforms the second portion while deforming the first portion in a substantially opposite manner. In this exemplary embodiment, the stimulations applied to the first and second portions during the first temporal period correspond to stimulation of the two portions in the alternating manner. This is seen in FIG. 10 in the push-pull portion of the chart.

As noted above, in an exemplary embodiment, the actuator assembly 761 is constructed and arranged and positioned such that the deflections of the membranes 773 and 783 result in corresponding deflections of the round window in the oval window, respectively, of the cochlea. More particularly, the actuator assembly 761 includes at least two fluid chambers 791 and 792, where the actuator assembly 761 is configured to respectively displace the fluids in the two fluid chambers (which may be the same type of fluid) to hydraulically transfer force from the actuator assembly to the cochlea, thereby stimulating the two separate portions of the cochlea (the round window and the oval window). The displacement of the fluid is achieved via the movement of the piezoelectric disk 793, which displaces both fluids simultaneously as a result of a single movement.

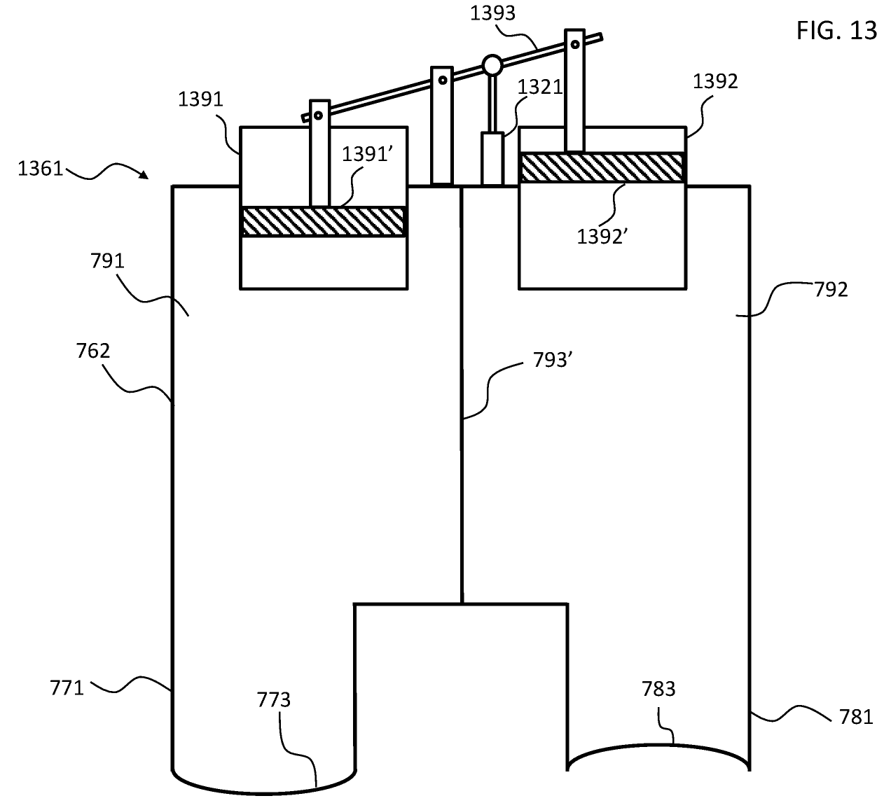

That said, in an alternative embodiment, the barrier between the two fluid chambers can be static, and two separate “pumps” can be utilized, as seen in FIG. 13, by way of example. In this regard, FIG. 13 depicts an actuator assembly 1361, which corresponds to actuator assembly 761 with at least some of the following differences. For example, actuator assembly 1361 has a non-flexible barrier 793′ instead of the piezoelectric disk assembly. Instead of the deformable disk 793, displacement cylinders 1391 and 1392 are present. The cylinders include pistons 1391′ and 1392′ that move in an alternating manner in and out (or, more precisely, towards and away) from chambers 791 and 792 respectively, thus varying the total volume of those chambers. As can be seen, a lever arrangement 1393 is utilized, where a single actuator 1321 drives the movement of the pistons 1391′ and 1392′ in an equal but opposite manner. That said, in an alternate embodiment, two separate actuators can be utilized to independently drive the two pistons in an alternating manner. In this regard, a control circuit such as a programs computer chip that controls the actuation of the actuators can be utilized to control the actuation of the separate actuators so as to achieve the dual actuation. Note further, that while the embodiment depicted in FIG. 13 utilizes two separate pistons, in an alternate embodiment, a single piston can be utilized, where the piston is manifolded to the two chambers 791 and 792 such that movement of the piston in one direction displaces fluid into a given chamber while displacing fluid from the other chamber and vice versa. Any arrangement that can enable the fluidic teachings detailed herein and/or variations thereof to be practiced can be utilized in at least some embodiments. Also, as will be detailed below, embodiments also include non-fluidic embodiments, and thus any arrangement that can enable the principles of operations detailed herein and/or variations thereof to be practiced can be utilized in at least some exemplary embodiments.

Still with a focus on the fluidic embodiments, the embodiment of FIG. 13 also illustrates a difference between this embodiment in the embodiment of f FIG. 7. In the exemplary embodiment of FIG. 7, the actuator assembly 761 is configured to hydraulically amplify displacement of the actuator assembly at the locations where the actuator assembly contacts the cochlea, whereas in the embodiment depicted in FIG. 13, the actuator assembly 1361 does not hydraulically amplify displacement of the actuator assembly at those locations. More particularly, in the embodiment of FIG. 7, the area of the piezoelectric disk 793 is approximately four times the area of the individual membranes 773 and 783. In this regard, in an exemplary embodiment, the diameter of the disk 793 is approximately twice that of the diameters of the membranes 773 and 783 (or, more particularly, the diameters of the deformable portions thereof). Conversely, in the embodiment of FIG. 13, the diameter of the piston is approximately the same as the diameters of the membranes 773 and 783, and thus there is no hydraulic amplification. That said, in alternative embodiments, the diameters can be larger or smaller to achieve hydraulic amplification and/or hydraulic deamplification.

Thus, in an exemplary embodiment, the actuator assembly is configured to respectively displace the fluids in the chambers 791 and 792 by controllably deforming a first component (e.g., piezoelectric disk 793) having a surface area that is larger than a displacement area of a second component (e.g., one of membranes 773 and 783) that is displaced as a result of the displacement of a respective fluid (the fluid within a given chamber), where the second component is at the location where the actuator assembly 761 contacts the cochlea (one of the round window or the oval window of the cochlea).

Moreover, in an exemplary embodiment, the area of deformation can be controlled so as to control the amount of amplification and/or deamplification. In this regard, in an exemplary embodiment, the piezoelectric disk can be a plurality of separate piezoelectric components, where only certain components are energized and/or deenergized depending on the desired area of deformation of the desk. With respect to the piston embodiment, in at least some exemplary embodiments, the pistons can be configured with a valve or the like that allows a controlled amount of fluid to flow past the pistons, so that a given deformation of a piston/a given movement of a piston displaces different amounts of fluid. Any arrangement that can enable a varying of the hydraulic amplification can be utilized in at least some exemplary embodiments.

It is briefly noted that with respect to the location(s) where the actuator assembly 761 contacts the cochlea, in an exemplary embodiment, the membranes 773 and or 783 can serve as a replacement for the round window and/or the oval window. In this regard, in an exemplary embodiment, the “legs” of the actuator assembly that supports the membranes 773 and 783 can be inserted through the structure that supports the round window and the oval window, respectively. In an exemplary embodiment, the legs can “fill” the passageways and/or otherwise seal the passageways that are present when the round and oval windows are removed, so as to prevent perilymph from flowing out of the cochlea. That said, in an alternate embodiment, the legs of the actuator assembly can be inserted into the cochlea or otherwise attached to the cochlea at other locations than the round window and/or the oval window in a manner that results in the transfer of the deformations of the membranes 773 and 783 into the fluid of the cochlea. In an exemplary embodiment, the orifice that results from the removal of the round window and/or oval window can be plugged by some structure. That said, in an alternate embodiment, an additional prostatic component can be utilized that prevents the deformation of the round window and/or oval window. That is, the round window and oval window can be present, but are prevented from moving as they normally would upon the establishment of waves of fluid motions in the cochlea. Instead, the function thereof is replaced by the diaphragms 773 and 783. In an exemplary embodiment, this can enable the utilization of the round window and/or the oval window at a later point in time in a customary manner. Indeed, in an exemplary embodiment, the ossicles can remain present, either connected to the tympanic membrane and/or disconnected to the tympanic membrane (awaiting connection at a later date). Such can have utilitarian value with respect to a scenario where the recipient has normal hearing, but engages in an endeavor that often results in hearing loss (e.g., becoming a successful rock star, a career artillery officer, etc.). In this regard, an exemplary embodiment entails utilizing the actuator assembly 761 or variations thereof to evoke a hearing percepts during a first temporal period of a recipient's life, and then utilizing the natural hearing path to evoke a hearing percepts during a second temporal period of the recipient's life after the first temporal period.

Note further, in an exemplary embodiment, the actuator assemblies detailed herein and/or variations thereof can be utilized to control the impact of loud noises on a recipient's hearing. In this regard, the actuator assemblies detailed herein can be utilized to dampen or soften the magnitude of the impact of sound on the cochlea. For example, the actuator assemblies can be transitioned an inoperative state during periods of loud noise. Indeed, in an exemplary embodiment, the actuator serves to dampen or otherwise cancel the noise. In this regard, the actuation of the actuator can be such that it actually cancels in whole or in part a portion of the movement of the oval window, thus dampening the resulting sound. Along these lines, with respect to the above-noted exemplary life choices, an artillery officer can engage the prosthetic device including one of the actuator assemblies detailed herein and/or variations thereof during periods of artillery bombardment, and then disengage the prosthetic device during periods where he or she is not utilizing things that make loud noises, such as a 155 millimeter recoilless cannon.

With respect to the just-described embodiment, it is noted that while the embodiments detailed herein focus on a dual actuation concept, some embodiments that cancel noise can be implemented utilizing a single action concept, where a single membrane deflects in an opposite direction of that of the oval window (e.g., out of the cochlea when the oval window is deflecting into the cochlea, and vice versa). Corollary to this is that in an alternate embodiment, this can be used to magnify the function of the cochlea, such as to hear things that are difficult to hear, or to at least partially remedy the effects of a hearing defect. In this regard, the deflections of the single membrane can be placed in phase.

In view of the above, it is noted that an exemplary embodiment includes a hearing prosthesis, such as the DACs 200A, detailed above, comprising at least one actuator (such as piezoelectric disk 793). In this exemplary embodiment, the hearing prosthesis includes a force transfer apparatus configured to transfer force from the at least one actuator to two separate locations of a beginning of a cochlea in a reciprocating manner. With respect to the embodiments detailed above in FIGS. 7 and 13, the force transfer apparatus is configured to transfer force from the at least one actuator to the two separate locations via fluid.

In some exemplary embodiments of the currently described exemplary embodiment, the force transfer apparatus includes a first fluid chamber (e.g., chamber 792) having a first boundary portion (e.g., the portion of the piezoelectric disk 793 facing the interior thereof, where the full boundary is established by pertinent walls of the housing 762, the membrane 783, the piezoelectric disk 793, and the support structure 794 thereof). The force transfer apparatus further includes a second boundary portion (e.g., membrane 793). In an exemplary embodiment, the force transfer apparatus includes a second fluid chamber (e.g., chamber 791) having a third boundary portion (e.g., the portion of the piezoelectric disk 793 facing the interior thereof) and a fourth boundary portion (the membrane 773). In this exemplary embodiment, the at least one actuator (e.g., piezoelectric disk 793) is configured to move the first boundary portion and the third boundary portion, the force transfer apparatus is configured such that movement of the first boundary portion forces the second boundary portion to move due to the fluid in the first chamber, and the force transfer apparatus is configured such that movement of the third boundary portion forces the fourth boundary portion to move due to the fluid in the second chamber. In this exemplary embodiment, the hearing prosthesis is configured such that when the actuator moves the first boundary portion in the first direction, the actuator moves the third boundary portion in the same direction relative to a fluid path connecting the two.

In an exemplary embodiment, the hearing prosthesis is configured such that the second boundary portion moves outward relative to the first chamber when the first boundary portion moves inward relative to the first chamber, and the fourth boundary portion moves inward relative to the second chamber when the third boundary portion moves outward relative to the second chamber. This is clearly seen in FIGS. 7-9, by way of example only and not by way of limitation. Corollary to all of this is that an exemplary embodiment of the hearing prosthesis is configured such that the first boundary portion moves inward relative to the first chamber when the third boundary portion moves outward relative to the second chamber.

As detailed above, the actuator of the actuator assembly is a piezoelectric disk actuator that flexes such that opposite sides of the disk move in the first direction upon application of electrical current thereto and flexes such that the opposite sides of the disk move in the second direction upon at least one of a cessation of application of the electrical current thereto or application of a current having an opposite polarity than that which was applied to flex the disk in the first direction. With respect to the former phenomenon, the piezoelectric disk 793 can have a relaxed state that is bowed in the direction of the second chamber 791, and only deforms into the direction of the first chamber 793 upon the application of the current. With respect to the latter phenomenon, the piezoelectric disk 793 can have a relaxed state that is flat/that neither extends in the first chamber nor extends in a second chamber without the application of a current thereto—the first polarity of the current causes the piezoelectric disk to deflect into the first chamber, and the second polarity (the opposite polarity) causes the piezoelectric disk to deflect into the second chamber.

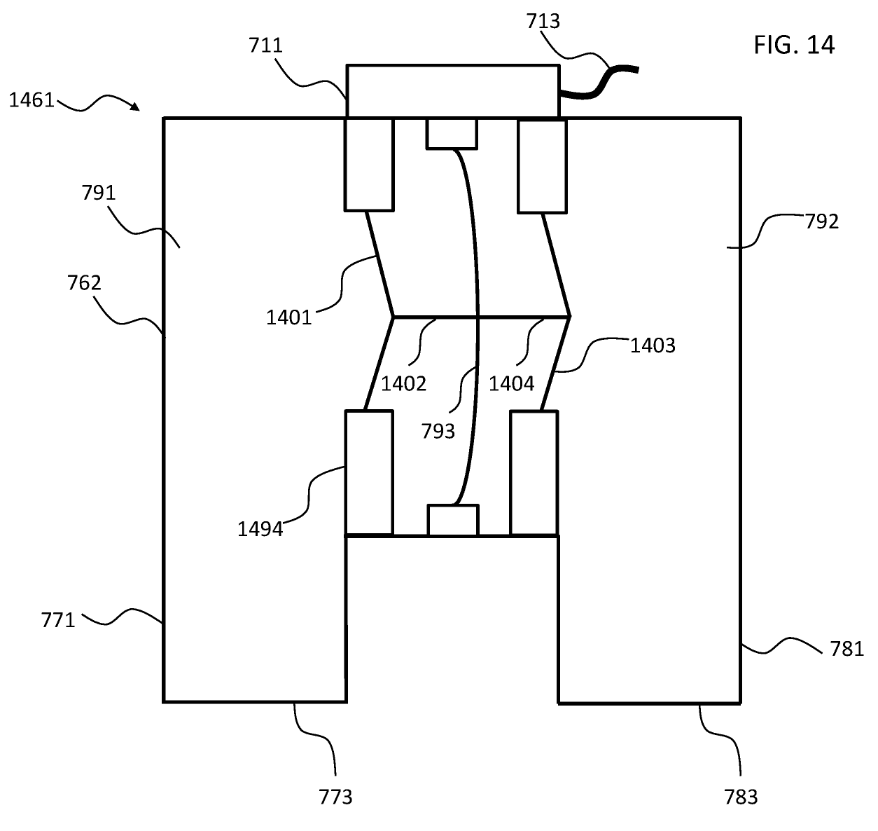

In some exemplary embodiments, the actuator assembly, and thus the hearing prosthesis of which the actuator assemblies apart, is configured such that deformation of the first and third boundaries is at least substantially identical to the deformation of respective sides of the piezoelectric disk. In this regard, this is because the first and third boundaries are established by the faces of the piezoelectric disk. That said, in an alternate embodiment, the piezoelectric disk can be isolated from the fluids in the chambers, and additional disks are located on either side of the disk, which are coupled to the piezoelectric disk. FIG. 14 depicts such an exemplary embodiment of an actuator assembly 1461, where the piezoelectric disk 793 is fluidically isolated via isolation disks 1401 and 1403 which are mounted on respective frames 1494, which disks are respectively coupled to the piezoelectric disk 793 via linkages 1402 and 1404, respectively. The deformation depicted in FIG. 14 is such that the volume of the chamber 792 contracts in the volume of the chamber 791 expands (the membranes 773 and 783 are not depicted as being deformed for ease of representation, but those membranes would be deformed in this exemplary embodiment.

It is noted that unless otherwise indicated, the disks, membranes and diaphragms detailed herein are circular. That said, in some alternate embodiments, these components can be oval, rectangular (square or otherwise), or any other shape. It is noted that in the embodiment depicted in FIG. 14, the isolation disks are depicted as having a diameter less than that of the piezoelectric disk 793. In this regard, this embodiment can be utilized to potentially deamplify the resulting hydraulic phenomenon. That said, in an alternate embodiment, the linkages 1402 and 1404 can be piezoelectric components themselves, which can be used to amplify the deflection of the piezoelectric disk 793 (at least in embodiments where the diameters of the isolation disks are about the same as and/or greater than the diameter of the piezoelectric disk 793.

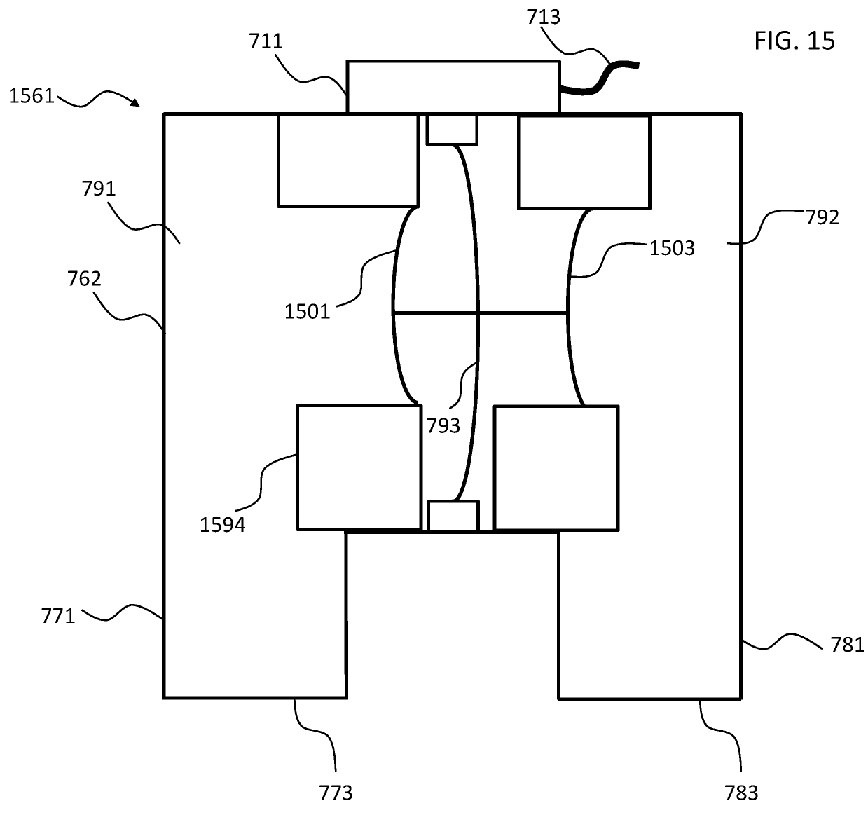

In an exemplary embodiment, the isolation disks 1401 and 1403 are membranes that the form only as a result of the forces applied via the linkages 1402 and 1404. That said, in an alternate embodiment, the isolation disks can also be piezoelectric disks, where, in an exemplary embodiment, not only are those disks moved as a result of deformation of the disk 793, but additional deformation is imparted onto the disks as a result of the particular deformations thereof In this regard, FIG. 15 depicts an exemplary actuator assembly 1561, where disks 1501 and 1503 are piezoelectric disks. Here, the piezoelectric disks 1501 and 1503 deform in an opposite manner relative to disk 793. In this regard, the center of the piezoelectric disks 1501 and 1503 is connected via the linkage to the center of the piezoelectric disk 793. It is the outer diameter of the piezoelectric disks 1501 and 1503 that moves upon actuation thereof In this regard, the support frames 1594 of the piezoelectric disks 1501 and 1503 are configured to permit the disks to move relative thereto, while maintaining a fluid-tight seal between the outer diameters of the respective disks and the frames. Indeed, in an exemplary embodiment, a membrane can be attached to the outer diameters and the frames. (It is noted that while the embodiment depicted in FIG. 15 depicts disks 1501 and 1503 as having a smaller diameter than the main disk 793, in alternative embodiments, the diameters can be the same in or greater than the main disk 793.) Thus, in this exemplary embodiment, the use of additional actuators can be utilized to build upon actuation of a single actuator to amplify (or deamplify) a given actuation stroke of the main actuator. Indeed, in an exemplary embodiment, these subactuators can be utilized to fine-tune the actuation system as a whole. It is further noted that in an exemplary embodiment of the embodiment of FIG. 15, the linkage between the disks and also be piezoelectric, thus further amplifying and/or deamplifying a given actuator stroke.

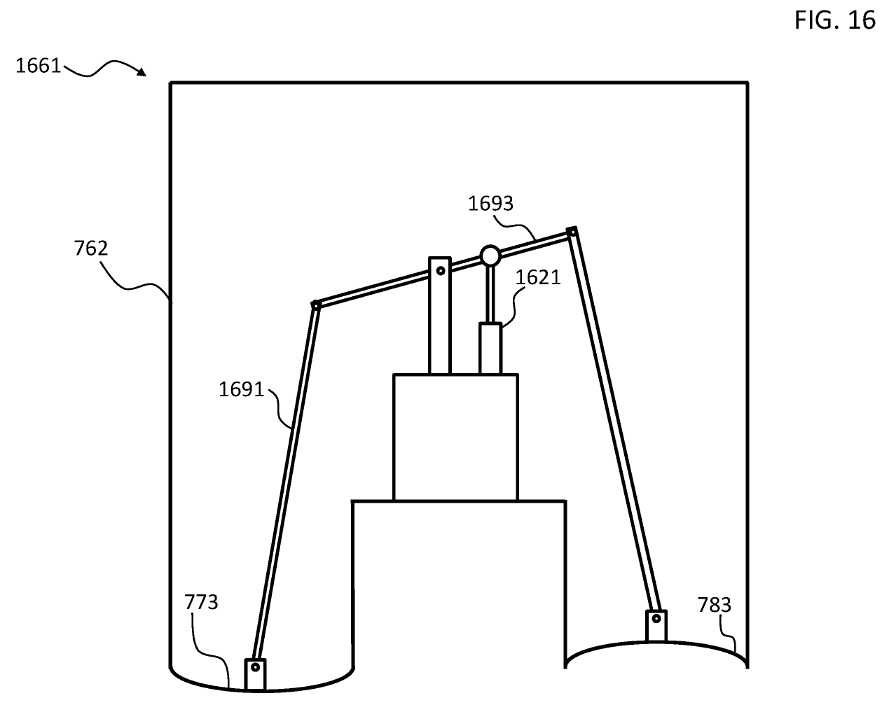

While the embodiments detailed herein up to this point have concentrated on the utilization of hydraulic principles to deform the membranes 773 and 783, alternate embodiments utilize other principles, such as direct mechanical actuation. In this regard, FIG. 16 depicts an exemplary embodiment of an actuator assembly 1661 that utilizes a single actuator 1621 and a lever assembly 1693 to reciprocatingly and/or alternatingly deform membranes 773 and 783. Here, a single reciprocating actuator 1621 is connected to the main lever of the lever assembly 1693. The lever assembly 1693 utilizes linkages 1691 to connect the main lever of the lever assembly 1693 to the respective membranes 773 and 783. While the embodiment depicted herein utilizes a reciprocating actuator 1621, which, in an exemplary embodiment, can be an electromagnetic actuator, is noted that in an alternate embodiment, the reciprocating actuator 1621 can be a piezoelectric component. Moreover, it is noted that in an exemplary embodiment, the piezoelectric disk 793 can be utilized without the fluid medium to achieve a similar result by linking the membranes 783 and 7732 the piezoelectric disk 793 utilizing linkage akin to linkage 1691. Any arrangement that can enable direct mechanical coupling between the actuators and the membranes can utilize in at least some exemplary embodiments.

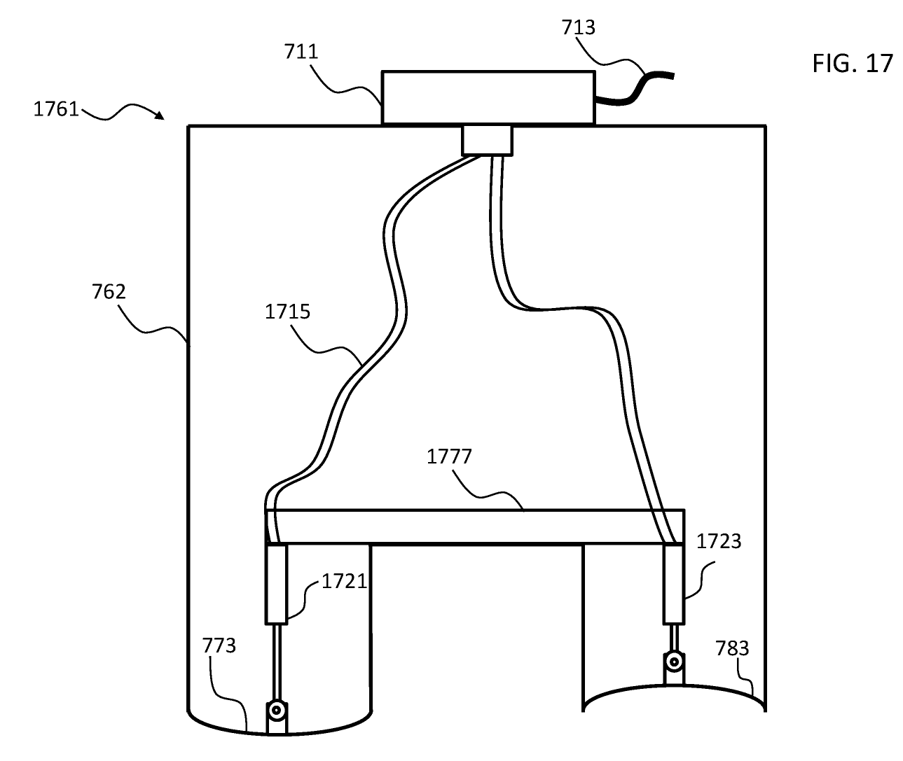

That said, in an alternate embodiment, separate actuators can be directly coupled to the membranes. FIG. 17 depicts an exemplary embodiment of an actuator assembly 1761, which utilizes two separate actuators 1721 and 1723. These separate actuators are directly coupled to membranes 1773 and 1783 respectively, as can be seen. These actuators are supported by actuator support structure 1777, which can be a beam or the like that is mounted to the housing 762. It is noted that at least some exemplary embodiments, actuator support structure 1777 is movable relative to the housing (e.g., such as by a third or fourth actuator assembly that is not shown), so as to adjust the position of the actuators 1721 and/or 1723. In an exemplary embodiment, adjustments of the actuator support structure 1777 can be utilized to fine-tune the system.

Shown in FIG. 17 are electrical leads 1751 which are connected to control unit 711. It is noted that some form of electrical communication system is present in the other embodiments utilizing the various actuators even if the leads are not depicted, which leads, etc. are not depicted for ease of illustration and clarity purposes.

While the embodiment depicted in FIG. 17 depicts an electromagnetic actuator, in alternative embodiments, a piezoelectric actuator can be utilized.

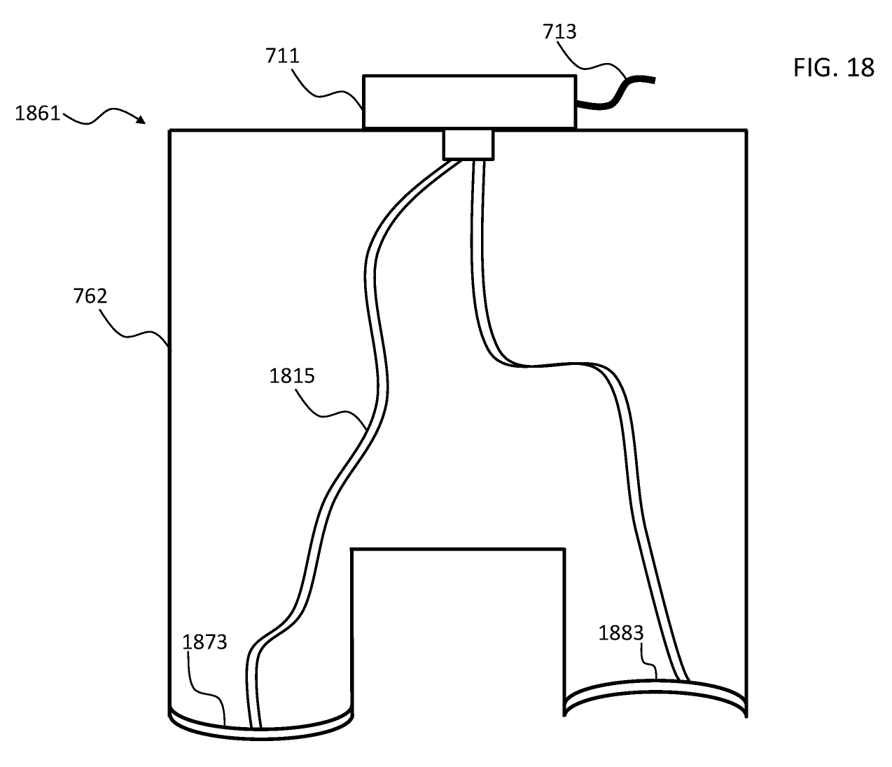

It is further noted that in at least some exemplary embodiments, the membranes 783 and 773, or, more accurately, components having a capability to deform in a manner analogous to the deformation of the membranes in a manner sufficient to enable the teachings detailed herein and/or variations thereof, can be piezoelectric disks themselves. That is, in an exemplary embodiment, the membranes 773 and 783 are replaced with piezoelectric disks, and the piezoelectric disks themselves the form without any other actuation (although additional other actuation can utilize in some alternate embodiments). FIG. 18 depicts such an exemplary embodiment, where piezoelectric disks 1873 and 1883 are located where the membranes 773 and 783 were previously located. (It is noted that the embodiment depicted in FIG. 18 is shown utilizing the housing of the embodiment of FIG. 7. This is utilized for ease of illustration in this embodiment, other types of housings and/or chassis supporting the various actuators can be utilized. This is the case with all the embodiments detailed herein, and not just the embodiment of FIG. 18.)

As can be seen, electrical leads 1815 extend from control unit 711 to the respective piezoelectric disks 1873 and 1883. In this embodiment, there is no hydraulic arrangement utilized to transfer the force from the disks to the respective windows of the cochlea. That said, in an exemplary embodiment, the piezoelectric disks 1873 and 1883 can be attached to membranes which are in turn attached to the respective windows. In this regard, in at least some exemplary embodiments, some embodiments of the piezoelectric material making up the piezoelectric disks may not necessarily be biocompatible. Thus, a biocompatible membrane can be located over the disks. In at least some embodiments, the membranes are directly located on the piezoelectric disks. In some alternate embodiments, linkages utilized to link the respective piezoelectric disks to the respective membranes. Any arrangement that can enable the teachings detailed herein and/or variations thereof to be practiced can be utilized in at least some exemplary embodiments.

In a manner parallel to controlling an area of deformation of the disk 793, the area of deformation of the disks 1873 and 1883 can be controlled so as to control the magnitude of the output forced. In this regard, in an exemplary embodiment, the piezoelectric disks can be a plurality of separate piezoelectric components, where only certain components are energized and/or deenergized depending on the desired area of deformation of the desk. This can also be applicable to an embodiment where actuators 1721 and 1723 are piezoelectric actuators. For example, the actuators 1721 and/or 1723 can piezoelectric stacks, where current is applied to a subset of the stacks so as to vary the magnitude. For example, in a stack of 10 different piezoelectric actuators, the output magnitude can be varied by energizing only one of the actuators or by energizing more than one, where energizing all 10 actuators can result in the greatest magnitude of output. Of course, the magnitudes of the given deformation are of a single piezoelectric actuator can be varied in traditional manners.

In view of the above, in at least some exemplary embodiments, there is a hearing prosthesis, such as the DACS 200A, including at least one actuator (e.g., disk 793, disks 1873 and 1883, etc.), wherein the hearing prosthesis is configured to apply a first force to a round window of a cochlea and apply a separate second force to an oval window of the cochlea such that deformation of the round window due to the respective applied force is balanced by at least about a substantially opposite deformation of the oval window, and deformation of the oval window due to the respective applied force is balanced by at least about a substantially opposite deformation of the round window. In an exemplary embodiment, the aforementioned forces are achieved in the push-pull mode, the push-relax mode, or the pull-relax mode. In an exemplary embodiment, the hearing prosthesis is configured such that the actuation of the actuator imparts one of a tensile force or a compressive force as the first force.

It is noted that in at least some embodiments, any of the embodiments detailed above can be utilized to achieve the just described principle of operation. In the case of the utilization of two separate actuators, a control system can be utilized to control the actuators. A feedback system can be utilized to gauge the output of the actuators, and the control system can be configured to adjust itself and/or the actuation of the actuators to achieve the aforementioned results. In this regard, the control unit 711 includes circuitry, such as a processor, with programming thereupon that can implement the teachings detailed herein. That said, in an alternative embodiment, it is the stimulation unit and/or the external component that includes the logic and/or circuitry and/or computer chips that can enable the control to achieve this principle of operation.

In an exemplary embodiment, the hearing prosthesis is configured to apply a third force to the oval window when the first force is applied to the round window, and the hearing prosthesis is configured to apply a fourth force to the round window when the second force is applied to the oval window. This is achieved, in an exemplary embodiment, by the push-pull mode, as noted above. In some embodiments, the first and third forces have equal and opposite magnitudes (e.g., as visually depicted by arrows 501C and 502T of FIG. 5). Still further in an exemplary embodiment, the second and fourth forces have equal and opposite magnitudes.

In some embodiments, the hearing prosthesis is configured to allow for substantially free deformation of the round window when the force is applied to the oval window, and the hearing prosthesis is configured to allow for substantially free deformation of the oval window when the force is applied to the round window. This is conceptually depicted with respect to FIGS. 4C and 4D.

While the embodiments discussed above have been directed towards scenarios where the actuator assembly is directly connected to the oval window, in some alternate embodiments, the actuator assembly is only indirectly connected to the oval window. In an exemplary embodiment, the actuator assembly is indirectly connected to the oval window as a result of being connected to a bony structure connected to the oval window (e.g., the stapes or a portion thereof that is left on the oval window). In an exemplary embodiment, the actuator assembly includes a stapes prosthesis, or a portion thereof, that connects to the oval window. In some embodiments, a stapes prosthesis can be utilized to connect to the round window as well. Any connection that can enable the teachings detailed herein and/or variations thereof to be practiced can be utilized in some embodiments.

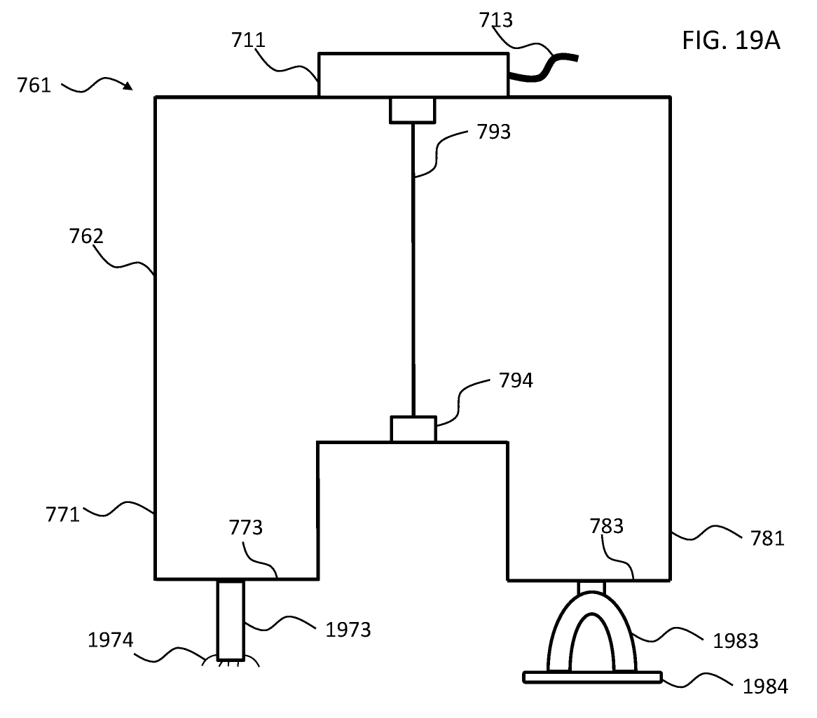

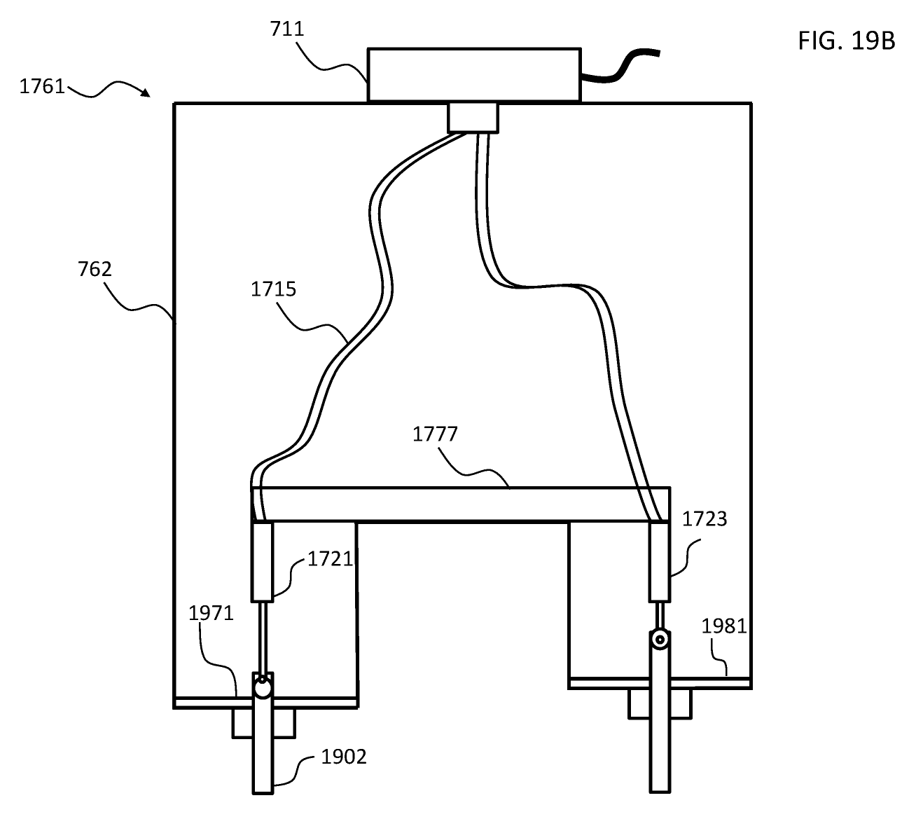

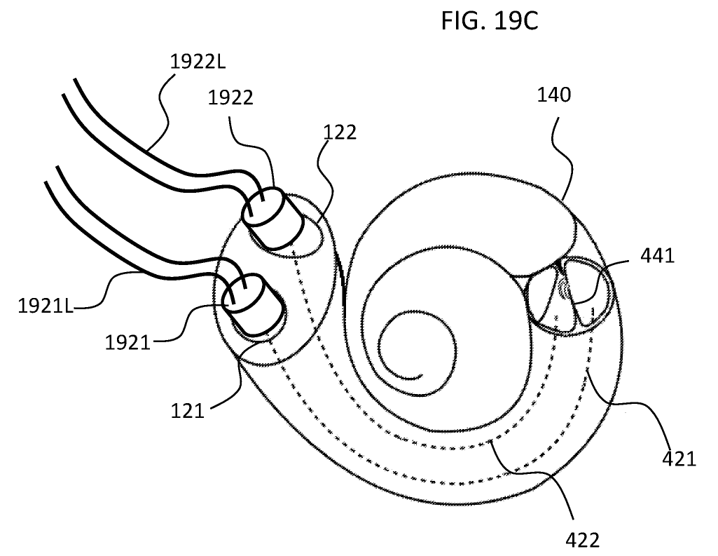

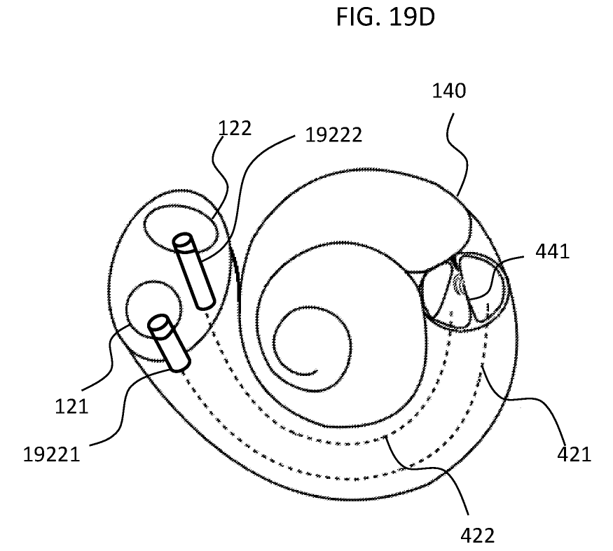

More specifically with respect to connection to the various windows, in an exemplary embodiment, the actuator assembly is configured such that the deflection of the membranes 773 and/or 783 corresponds to the deflection of the tissue of the round and oval window is respectively. In this regard, the membranes 773 and 783 can mimic or otherwise quasi-duplicate the deformations of the round and oval window. In an embodiment where the membranes 773 and/or 783 are adhesively connected to the windows, the portions of the windows connected to membranes 773 and 783 deform in a one-to-one relationship with the deformation of those membranes. Any arrangement that can couple the membranes directly to the windows can utilize in at least some exemplary embodiments providing that such can enable the teachings detailed herein. That said, as noted above, the membranes can be indirectly coupled to the windows. In this regard, FIG. 19A depicts some exemplary embodiments of an indirect coupling between the membranes and the windows. With respect to the coupling component 1983 on the right side of the stimulating assembly 761, coupling component 1983 is configured to generally replicate the functionality of the stapes and the interaction thereof with the oval window. While the coupling component 1983 is presented with a plate 1984 which replicates the bony structure between the stapes and the oval window, in some alternate embodiments, coupling component 1983 does not include plate 1984. Instead, in some exemplary embodiments, the U shaped portion of component 1983 is directly connected to the bony structure of the oval window if such remains after and/or the result of the implantation process. That said, in alternate embodiments, the coupling 1983 need not include a use a portion replicative of the stapes. Instead, a uniform beam can be utilized, such as is depicted by way of example with respect to coupling component 1973, which can be coupled to a plate 1984 or directly coupled to the bony structure of the oval window.

It is noted that the coupling component 1983 can be located on the left side of the actuator assembly as well in some alternate embodiments instead of and/or in addition to being located on the right side of the embodiment. That is, in some exemplary embodiments, coupling 1983 interface with the round window and/or the oval window.

With respect to the coupling component 1973 depicted on the left side of the actuator assembly, coupling component 1973 can include pronged or toothed components 1974 that gripped or otherwise placed into the tissue of the window (in this case, the round window) or the bony structure associated there with if present. It is noted that the coupling component 1973 can be utilized to couple to the round window and/or the oval window (that is, one coupling component is used coupled to the round window, and one coupling component is used to couple to the oval window).

While the embodiment depicted in FIG. 19A depicts the coupling components connected to membranes 773 and 783, alternative embodiments can have such coupling components connected to other components, such as the piezoelectric disks 1873 and 1883. Moreover, embodiments of the actuator assembly can be practiced where there is no deformable component such as a membrane or a piezoelectric disk in direct or indirect contact with the windows. In this regard, FIG. 19B depicts an exemplary embodiment of actuator 1761 where the actuators 1721, and 1723 are coupled to connection components 1902, which are cylindrical rods that extend through barriers 1971 and 1981. In an exemplary embodiment, the connection components 1902 can be attached to the plates and/or to the piercing components or any other components that will enable the rods to be attached to the round and/or oval window and/or associate a structure that with or any other structure that will enable the teachings detailed herein. Any coupling apparatus actuated by any arrangement that can enable the teachings detailed herein and/or variations thereof can be utilized in at least some exemplary embodiments, along with any arrangement that can actuate those coupling components.

Still further, while the embodiments detailed above have been directed towards an apparatus that couples to or otherwise is connected to one of the windows or both of the windows, in alternative embodiments, couplings are not utilized, and/or the components of the actuator assembly that transfer the deformations or otherwise movements to the round and/or oval windows are not coupled to the round and oval windows. By way of example only and not by way limitation, with respect to the actuators operating in the push-relaxed mode, rods 1902 (or any other component connected thereto, such as a plate, etc.) can be in contact with the round and/or oval windows, but they are not connected or coupled to the round and/or oval windows. This is because in at least some exemplary embodiments of the push-relaxed mode, there can be utilitarian value with respect to only pushing on the round windows without coupling the actuator to those windows.

In some embodiments, now with reference to the embodiments of, for example, FIGS. 17 and 18, the hearing prosthesis includes two actuators, and the hearing prosthesis is configured such that the actuators are synchronized such that when the first force is applied, the second force is one of not applied or applied having a magnitude of at least about the same as that of the first force but in at least about a substantially opposite magnitude. In this exemplary embodiment. The hearing prosthesis is configured such that the actuators are synchronized such that when the second force applied, the first force is one of not applied or applied having a magnitude of at least about the same as that of the second force but in at least about a substantially opposite magnitude. In an exemplary embodiment, this synchronization can be achieved via control unit 711, or by the stimulator unit, etc.

In some embodiments, the hearing prosthesis is configured such that, with one or more actuators, the application of the first and the second force is synchronized such that upon application of the first force, the second force is one of not applied or applied having a magnitude of at least about the same as that of the first force but in at least about a substantially opposite magnitude and upon application of the second force, the first force is one of not applied or applied having a magnitude of at least about the same as that of the second force but in at least about a substantially opposite magnitude.

With respect to the magnitudes of the forces that are applied to the various portions of the cochlea, in an exemplary embodiment, the various actuator assemblies detailed herein are configured to apply the same magnitude for a given cycle. That said, in an alternate embodiment, the various actuator assemblies detailed herein are configured to apply a force that has different magnitudes for a given cycle. In this regard, by way of example, with reference to FIGS. 5 and 6, force 501C and 502T can have equal magnitudes (which are opposite, and thus the magnitudes detailed herein are absolute values) or, in some alternate embodiments, can have different magnitudes. Moreover, force 501T and 502C can have equal magnitudes, or, in some alternate embodiments, can have different magnitudes. Further, forces 501C and 501T can have different magnitudes, and forces 502T and 502C can have different magnitudes. Force 501C and 502C can have different magnitudes, and force 501T and 502T can have different magnitudes. That said, any of the aforementioned forces can have the same magnitudes in some alternate embodiments. Moreover, in an exemplary embodiment, at least some actuators are configured to vary the magnitudes of the applied forces from one cycle to another cycle and/or during the same cycle. Any arrangement that can enable the teachings detailed herein and/or variations thereof to be practiced can be utilized in at least some exemplary embodiments.

It is further noted that in at least some exemplary embodiments, the actuator assembly of the hearing prosthesis of some embodiments can entail two separate actuators that are linked to one another only as a result of the fact that they are in electrical communication with the stimulation unit 220 and as a result of the fact that they are both connected to portions of the cochlea and/or the portions of the recipient that form the interface between the middle ear and the inner ear. In this regard, FIG. 19C depicts in an exemplary embodiment where the actuator assembly includes an actuator 1922 that applies stimulation to the oval window of the cochlea and an actuator 1921 that applies stimulation to the round window. The actuators 1922 and 1921 are separately linked or separately coupled to the recipient and have separate lead assemblies 1922L and 1921L that place the actuators into signal communication with the stimulator unit 220.

FIG. 19D depicts an alternate embodiment where the actuator assembly of the hearing prosthesis includes actuators 19222 and 99211 that are located inside the cochlea (on separate sides of the cochlear partition 441.

It is noted that some exemplary embodiments include methods, as will now be detailed.

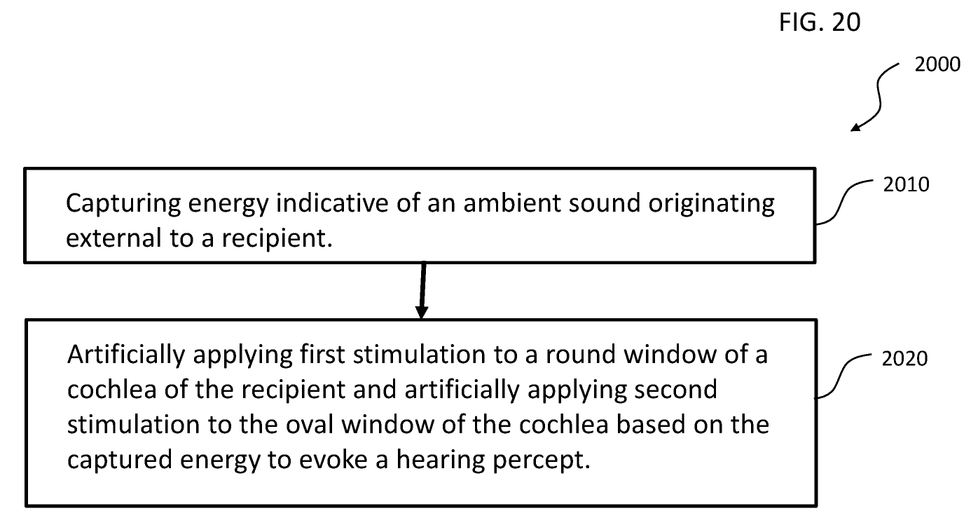

FIG. 20 depicts a flowchart for an exemplary method 2000. Method 2000 includes method action 2010, which entails capturing energy indicative of an ambient sound originating external to the recipient. In an exemplary embodiment, this can be achieved via a microphone of the like on the external component 242, or remotely from the external component. Alternatively, in some exemplary embodiments, this can be achieved via an implanted microphone that is implanted beneath the skin of the recipient. Any arrangement that will enable the capture of energy indicative of an ambient sound can be utilized in at least some exemplary embodiments.

Method action 2000 further includes method action 2020, which entails artificially applying a first stimulation to a round window of a cochlea of the recipient and artificially applying a second stimulation to the oval window of the cochlea based on the captured energy to evoke a hearing percept. In an exemplary embodiment, the first and second stimulation is applied with an opposite phase. In an exemplary embodiment, the first and second stimulation corresponds to the stimulation in a push-relax mode, or a pull-relax mode. In an exemplary embodiment, the first and second simulations correspond to the pushes or the pulls of the push-pull mode. In this regard, in an exemplary embodiment, the artificial stimulations are respective pushing stimulations on the round and oval windows. Alternatively, in another exemplary embodiment, the artificial stimulations are respective pulling stimulations on the round and oval windows.

By way of example, with respect to the chart on page 10, in the push-pull mode, the first and second stimulations can be forces 501T and 502T, or can be forces 501C and 502C, respectively. In the pull-relax mode, the first and second forces can be 501T and 502T, and in the push-relax mode, the first and second forces can be forces 502C and 501C.

It is noted that in some embodiments, method 2000 is executed by artificially applying a third stimulation to the round window and artificially applying a fourth stimulation to the oval window based on the captured energy to evoke a hearing percept. In some exemplary embodiments of the exemplary embodiments the third and fourth stimulation is applied with an opposite phase relative to one another, the first and fourth stimulation is applied in phase with one another and the second and third stimulation is applied in phase with one another. By way of example, with respect to the chart on page 10, in the push-pull mode, the first and second stimulations can be forces 501T and 502T, and the third and fourth stimulations can be forces 501C and 502C, respectively (or visa-versa). As will be understood from FIG. 10, the first and second stimulations can be pushing stimulations, and the third and fourth stimulations can be pulling stimulations (or visa-versa).

It is noted that any disclosure of an apparatus herein corresponds to a disclosure of a method of utilizing that apparatus for the purposes disclosed herein (e.g., to evoke a hearing percept, to provide stimulation to the cochlea, etc.). It is further noted that any disclosure of any method actions herein corresponds to a disclosure of a device for implementing those method actions. Further, it is noted that any disclosure of a device herein corresponds to a disclosure of making a device, and any disclosure of making a device herein corresponds to a disclosure of the resulting device.

While various embodiments of the present invention have been described above, it should be understood that they have been presented by way of example only, and not limitation. It will be apparent to persons skilled in the relevant art that various changes in form and detail may be made therein without departing from the scope of the invention. Thus, the breadth and scope of the present invention should not be limited by any of the above-described exemplary embodiments, but should be defined only in accordance with the following claims and their equivalents.

What is claimed is:

1. A device comprising:
a hearing prosthesis configured to provide mechanical stimulation to two separate portions of a barrier between the middle ear and the inner ear in an alternating manner to evoke a hearing percept.

2. The device of claim 1, wherein:
the device is configured to apply mechanical stimulation to a round window of the cochlea and an oval window of the cochlea in an alternating manner, thereby evoking the hearing percept.

3. The device of claim 2, wherein:
the hearing prosthesis is configured to apply a push-pull stimulation to the round window and a pull-push stimulation to the oval window, where the push stimulation to the round window is accompanied by a pull stimulation to the oval window, and visa-versa.

4. The device of claim 1, wherein:
the mechanical stimulation is a stimulation that deforms, during a first temporal period, a first portion of the two portions while at least permitting a second portion of the two portions to deform in a substantially opposite manner and, during a second temporal period separate from the first temporal period, deforms the second portion while at least permitting the first portion to deform in a substantially opposite manner; and
the stimulations applied during the first temporal period and the second temporal period correspond to stimulation of the two separate portions in the alternating manner.

5. The device of claim 1, wherein:
the mechanical stimulation is a stimulation that deforms, during a first temporal period, a first portion of the two portions while deforming the second portion of the two portions in a substantially opposite manner and, during a second temporal period separate from the first temporal period, deforms the second portion while deforming the first portion in a substantially opposite manner; and
the stimulations applied to the first and second portions during the first temporal period corresponds to stimulation of the two portions in the alternating manner.

6. The device of claim 5, wherein:
the first portion is a round window of the cochlea and the second portion is an oval window of the cochlea.

7. The device of claim 1, further comprising:
an actuator; and
two fluid chambers, wherein the actuator is configured to respectively displace the fluids in the two fluid chambers to hydraulically transfer force from the actuator to the cochlea, thereby stimulating the two separate portions of the cochlea.

8. The device of claim 7, wherein:
the device is configured to hydraulically amplify displacement of the actuator at locations where the device contacts the cochlea.

9. The device of claim 8, wherein:
the device is configured to respectively displace the fluids by controllably deforming a first component having a surface area that is larger than a displacement area of a second component that is displaced as a result of the displacement of a respective fluid, where the second component is at the location where the device contacts the cochlea.

10. A hearing prosthesis, comprising:
at least one actuator; and
a force transfer apparatus configured to transfer force from the at least one actuator to two separate locations of a beginning of a cochlea in a reciprocating manner.

11. The hearing prosthesis of claim 10, wherein:
the force transfer apparatus is configured to transfer force from the at least one actuator to the two separate locations via fluid.

12. The hearing prosthesis of claim 10, wherein:
the force transfer apparatus includes at first fluid chamber having a first boundary portion and a second boundary portion;
the force transfer apparatus includes a second fluid chamber having a third boundary portion and a fourth boundary portion;
the at least one actuator is configured to move the first boundary portion and the third boundary portion;
the force transfer apparatus is configured such that movement of the first boundary portion forces the second boundary portion to move due to the fluid in the first chamber; and
the force transfer apparatus is configured such that movement of the third boundary portion forces the fourth boundary portion to move due to the fluid in the second chamber.

13. The hearing prosthesis of claim 12, wherein:
the hearing prosthesis is configured such that when the actuator moves the first boundary portion in the first direction the actuator moves the third boundary portion in the same direction relative to a fluid path connecting the first boundary portion to the third boundary portion.

14. The hearing prosthesis of claim 13, wherein:
the actuator is a piezoelectric disk actuator that flexes such that opposite sides of the disk move in the first direction upon application of electrical current thereto and flexes such that the opposite sides of the disk move in the second direction upon at least one of a cessation of application of the electrical current thereto or application of a current having an opposite polarity than that which was applied to flex the disk in the first direction.

15. The hearing prosthesis of claim 14, wherein:
the hearing prosthesis is configured such that deformation of the first and third boundaries is at least substantially identical to the deformation of respective sides of the disk.

16. The hearing prosthesis of claim 13, wherein the force transfer apparatus is configured such that:
the second boundary portion moves outward relative to the first chamber when the first boundary portion moves inward relative to the first chamber; and
the fourth boundary portion moves inward relative to the second chamber when the third boundary portion moves outward relative to the second chamber.

17. The hearing prosthesis of claim 16, wherein:
the hearing prosthesis is configured such that the first boundary portion moves inward relative to the first chamber when the third boundary portion moves outward relative to the second chamber.

18. A hearing prosthesis, comprising:
at least one actuator, wherein
the hearing prosthesis is configured to apply a first force to a round window of a cochlea and apply a separate second force to an oval window of the cochlea such that deformation of the round window due to the respective applied force is balanced by at least about a substantially opposite deformation of the oval window, and deformation of the oval window due to the respective applied force is balanced by at least about a substantially opposite deformation of the round window.

19. The hearing prosthesis of claim 18, wherein:
the hearing prosthesis is configured to apply a third force to the oval window when the first force is applied to the round window; and
the hearing prosthesis is configured to apply a fourth force to the round window when the second force is applied to the oval window.

20. The hearing prosthesis of claim 19, wherein:
the first and third forces have equal and opposite magnitudes; and
the second and fourth forces have equal and opposite magnitudes.

21. The hearing prosthesis of claim 18, wherein:
the hearing prosthesis is configured to allow for substantially free deformation of the round window when the force is applied to the oval window; and
the hearing prosthesis is configured to allow for substantially free deformation of the oval window when the force is applied to the round window.

22. The hearing prosthesis of claim 18, wherein:
the hearing prosthesis is configured to be directly connected to at least one of the oval window or a bony structure connected thereto; and
the hearing prosthesis is configured to be directly connected to the round window.

23. The hearing prosthesis of claim 18, wherein:
the hearing prosthesis is configured such that the actuation of the actuator imparts one of a tensile force or a compressive force as the first force.

24. The hearing prosthesis of claim 18, further comprising:
a second actuator, wherein:
the hearing prosthesis is configured such that the actuators are synchronized such that when the first force is applied, the second force is one of not applied or applied having a magnitude of at least about the same as that of the first force but in at least about a substantially opposite magnitude; and
the hearing prosthesis is configured such that the actuators are synchronized such that when the second force applied, the first force is one of not applied or applied having a magnitude of at least about the same as that of the second force but in at least about a substantially opposite magnitude.

25. The hearing prosthesis of claim 18, wherein:
the hearing prosthesis is configured such that application of the first and the second force is synchronized such that:
upon application of the first force, the second force is one of not applied or applied having a magnitude of at least about the same as that of the first force but in at least about a substantially opposite magnitude; and
upon application of the second force, the first force is one of not applied or applied having a magnitude of at least about the same as that of the second force but in at least about a substantially opposite magnitude.

26. A method, comprising:
capturing energy indicative of an ambient sound originating external to a recipient; and
artificially applying first stimulation to a round window of a cochlea of the recipient and artificially applying second stimulation to the oval window of the cochlea based on the captured energy to evoke a hearing percept, wherein the first and second stimulation is applied with an opposite phase.

27. The method of claim 26, wherein:
the artificial stimulations are respective pushing stimulations on the round and oval windows.

28. The method of claim 26, wherein:
the artificial stimulations are respective pulling stimulations on the round and oval windows.

29. The method of claim 26, further comprising:
artificially applying a third stimulation to the round window and artificially applying a fourth stimulation to the oval window based on the captured energy to evoke a hearing percept, wherein
the third and fourth stimulation is applied with an opposite phase relative to one another,
the first and fourth stimulation is applied in phase with one another, and
the second and third stimulation is applied in phase with one another.

30. The method of claim 29, wherein:
the first and second stimulations are pulling stimulations; and
the third and fourth stimulations are pushing stimulations.
